(19) United States
(12) Patent Application Publication
(10) Pub. No.: US 2014/0214670 A1
(43) Pub. Date: Jul. 31, 2014

(54) METHOD FOR VERIFYING A CONSUMER'S IDENTITY WITHIN A CONSUMER/MERCHANT TRANSACTION

(71) Applicant: Jason C. McKenna, Sayreville, NJ (US)

(72) Inventor: Jason C. McKenna, Sayreville, NJ (US)

(21) Appl. No.: 13/754,060

(22) Filed: Jan. 30, 2013

(51) Int. Cl. G06Q 20/40

(52) U.S. Cl. CPC G06Q 20/40145
USPC 705/44

(57) ABSTRACT

A method for verifying a consumer's identity in connection with a consumer/merchant transaction, including receiving a user-identifier from a user, receiving a unique device identifier from an electronic device associated with the user, associating the user-identifier and the unique device identifier of the user to a user account residing on a secured transaction server (“STS), the STS not operated by the merchant and including an identity verification agent. The method further includes receiving a consumer identity verification request at the STS, receiving a unique device identifier associated with an electronic device of the consumer at the STS, comparing, through the identity verification agent, the user's unique device identifier and the consumer's unique device identifier to determine at least one of a positive or negative user-identity verification, and then communicating to the merchant the at least one of the positive or negative user-identity verification.

### FIELD OF THE INVENTION

The present invention relates to a method utilized to facilitate secured transactions, and, more particularly, relates to systems of verifying a consumer's identity with merchant/consumer transaction, particularly financial transactions.

### BACKGROUND OF THE INVENTION

With the number of financial transactions carried out all over the world and the potential for theft or misuse of data, many persons have a strong need to protect their financial information. A majority of these financial transactions are through consumer/merchant transactions. Often, these transactions employ the use of credit cards, debit cards, e-checks, and the like. Typically, these transactions consist of the consumer providing the merchant with his or her financial information, e.g., credit/debit card number, authorization code, and/or pin. Depending on the type of payment, the merchant routes the payment request to the applicable financial institution of the consumer. With regard to credit card transactions, the merchant sends its request to an acquiring bank (also referred to as a “merchant bank”) that relays the request through a card network (e.g., VISA, MasterCard, Discover) associated with the card to the applicable financial institution (also referred to as an “issuer”). The issuer then sends an “authorization” to the merchant bank essentially informing the merchant bank that the transaction is either approved or denied.

This process continues throughout the day by the merchant bank/financial institution. Generally, at the end of the day/week, the merchant bank sends the “batch” of authorization codes back to the issuer for payment. This process is often referred to as “settlement” and, for credit cards, can take 2 to 3 days for the process to be carried out. This process often exposes merchants to fees from the card networks and merchant banks. With fraud, e.g., identity theft, sweeping the globe, protecting the financial information and identity of the consumer has been problematic for merchants and consumers alike.

In many instances where fraudulent transactions occur, those above-described fees charged to the merchants are not refundable, even though consumers are able to get their money back through “chargebacks.” In those cases where the fees are refunded, the merchants are still charged a percentage of the fees for accepting the fraudulent transaction. Typical methods of confirming a consumer's identity before the financial transaction, such as confirming the signature on the back of the card and/or viewing a consumer's identification, fall short of effectively preventing fraudulent transactions. Fraud prevention duties are generally placed in the hands of agents of the merchants, i.e., tellers/clerks that often forget, are indifferent, or are unable to detect fraud. In many instances, intelligent criminals effectively imitate a consumer's identification, leaving even the most observant agents helpless. In additional to financially harming the merchant, the goodwill and reputation of merchants are also affected by these fraudulent transactions, as consumers often believe merchants are partly to blame.

Consumers are also affected by the increased costs and expenses subjected on the merchant as those costs/expenses are often absorbed into the products being offered by the merchant. Furthermore, most consumers are directly impacted by the fraudulent transactions as the payments are removed from their accounts. This is extremely problematic for those consumers using debit cards for financial transactions as this money is directly, and often instantaneously, removed from consumers' checking accounts. Furthermore, with the advent of laws preventing consumers from contesting certain charges after a period of time, preventing fraudulent transactions, or at the very minimum notifying consumers of such transactions, is important. As such, consumers desire an effective and efficient way to prevent fraudulent transactions and identify unauthorized users of their financial accounts. It should be noted that the term “consumer” is defined herein as a person or entity making or conducting the financial transaction. The term “user” is defined herein as a person or entity that owns or is authorized to make or conduct the financial transaction. These terms, however, are not mutual exclusive, meaning that in many instances the user is often the consumer. In some instances, i.e., fraudulent transactions, the consumer is not the user.

There are many known processes and devices attempting to effectively prevent or minimize fraudulent financial transactions, but many of these processes and devices attempt to solve the problems by piecemeal solutions, such as sending additional notifications to a merchant to remind it to check or verify the consumer's identity. These processes, however, do not provide a complete end-to-end purchasing process to effectively reduce fraudulent transactions. For one, most known processes and devices require, at some point, the consumer to provide the merchant his or her financial information. For authorized users conducting transactions, this is problematic as fraud may occur from within the merchant, e.g., employees or agents of the merchant taking and using the user's financial information. This is due to the fact that many merchants store the consumer's financial information on their server for up to three years. Disadvantageously, for a user/consumer who continually makes purchases with, for example, a credit card, many merchants receive and store the user's financial information. Those processes requiring the consumer to provide financial information also easily facilitate fraudulent or unauthorized transactions for the above-described reasons, e.g., merchants do not check to verify the identity of the consumer.

Some known processes require a pre-authorization or verification between the user and the user's financial institution before conducting a financial transaction. These processes require the user to physically present his or her card to an authorizing agent in order to receive an identification code that is stored on a third party's server and kept with the user. Should the user desire to make a purchase, the user has to give the merchant the verification code and financial information. These methods are primarily to prevent fraud for web-based transactions and require the merchant to be in communication with the third party server. Although these processes may benefit merchants, specifically web-based merchants, it does not fully protect the user, as the financial information is still given to the merchant to store and use. Disadvantageously, the user is required to remember and/or store the identification code. Moreover, this process would be inapplicable or redundant in non-web-based financial transactions.

Some other known processes used to prevent fraudulent transactions involve third parties communicating identification information of a user to a merchant upon receiving a funds request from that merchant. These methods and devices initially receive the user's identifying information before the transaction is carried out and store the user's identification information, e.g., photo, signature, address, on a database associated with the third party. When the user's financial information is used, the merchant receives the user's photo, signature, etc. These methods suffer from many of the above-described deficiencies; specifically, the user's financial information is still given to the merchant. These processes are unable to bypass this step as typically there is not a known and/or effective method of getting payment to the merchant without giving the merchant the financial information. Even more specifically, most, if not all, of these known processes do not involve electronic mobile devices within the consumer/merchant financial transaction.

It is clear that merchants and consumers desire simple, secure, and ubiquitous methods and devices for reducing fraud and identity theft. Therefore, a need exists for a method and device of reducing fraudulent transactions and preventing identify theft.

### SUMMARY OF THE INVENTION

The invention provides a fraudulent transaction reduction system, method, and device that overcomes the hereinafore-mentioned disadvantages of the heretofore-known devices and methods of this general type.

Although the invention is illustrated and described herein as embodied in a method and device for conducting secured transactions with a merchant, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

The present invention provides a method and device for reducing fraudulent transactions by utilizing a mobile electronic device associated with an authorized user to confirm and/or verify the consumer's identity when making a financial transaction with a merchant. In one exemplary embodiment, the inventive process requires a user to register with a third party having a secured transaction server, thereby storing the user's identification information and the portable electronic devices′, e.g., a phone's, identifying information. The consumer then uses the phone that is communicatively coupled to a network, such as a computer network, to scan/receive information associated with one or more merchant products, including price. The consumer then sends that information to the secured transaction server where the third party participates in an authentication process based on one or more verification parameters. These verification parameters may include, but aren't necessarily limited to, comparing user identification data to the consumer identification data (e.g., retinal scans comparisons, photo identification, signature comparisons, voice comparisons, etc.), comparing phone identifying information of the user to phone identifying information of the consumer (e.g., unique address information, specific components located on a user's/consumer's mobile device 104, ambient light sensors, global positioning sensors (GPS), etc.), and compiling and analyzing social media information of the user. All of these verification and identification means may be used independent of, or in combination with, one another.

After the merchant receives verification from the secured transaction server, the secured transaction server, or the merchant, sends a request to the user/consumer's financial institution for authorization. Once authorization has been approved by the financial institution, the merchant receive payment though traditional settlement means. Although the present invention provides fraud prevention within the application of merchant/consumer transaction, it shall not be so limited, and the above- and below-described features may be applied for identity verification in the areas of medical records/payment, governmental services, corporate/employee transactions, internet and web-based transactions, among others.

With the foregoing and other objects in view, there is provided, in accordance with the invention, a method for verifying a consumer's identity in connection with a transaction involving a consumer and a merchant includes the steps of receiving a user-identifier from a user, receiving a unique mobile device identifier from a mobile electronic device associated with the user, associating the user-identifier and the unique mobile device identifier of the user to a user account that resides on or is at least accessible to a secured transaction server, where the secured transaction server is not operated by the merchant and includes an identity verification agent. The method further includes the steps of receiving a consumer identity verification request, from a mobile electronic device of the consumer and/or the merchant, at the secured transaction server, where the mobile electronic device of the consumer and the merchant are communicatively coupled, over a network, to the secured transaction server. The method further includes receiving a unique mobile device identifier associated with the mobile electronic device of the consumer at the secured transaction server, comparing, through the identity verification agent, the user's unique mobile device identifier, and the consumer's unique mobile device identifier to determine a positive user-identity verification and/or a failed user-identity verification. The method also includes communicating to the merchant the positive user-identity verification or the failed user-identity verification for a user-identity-verification indicator.

In accordance with another feature, an embodiment of the present invention includes initiating a secondary user authentication upon determining the at least one of the positive user-identity verification and the failed user-identity verification.

In accordance with a further feature of the present invention, the secondary user authentication includes receiving a user's biometric data, receiving a consumer's biometric data, and comparing, through the identity verification agent, the user's biometric data and the consumer's biometric data to determine the at least one of the positive user-identity verification and the failed user-identity verification.

In accordance with a yet another feature of the present invention, the consumer's biometric data is obtained through the mobile electronic device of the consumer.

In accordance with one more feature of the present invention, the secondary user authentication includes the steps of receiving a passcode from the user, receiving a passcode from the consumer, and comparing, through the identity verification agent, the user's passcode and the consumer's passcode to determine the at least one of the positive user-identity verification and the failed user-identity verification.

In accordance with still another feature of the present invention, the consumer's biometric data is obtained through the mobile electronic device of the consumer.

In accordance with an additional feature of the present invention, the secondary user authentication includes receiving a passcode from the user, receiving a passcode from the consumer, and comparing, through the identity verification agent, the user's passcode and the consumer's passcode to determine the at least one of the positive user-identity verification and the failed user-identity verification.

In accordance with still another feature of the present invention, the secondary user authentication includes receiving a plurality of mobile-device-component identifiers from the mobile device of the user, receiving a plurality of mobile-device-component identifiers from the mobile device of the consumer, and comparing, through the identity verification agent, the user's plurality of mobile-device-component identifiers and the consumer's plurality of mobile-device-component identifiers to determine the at least one of the positive user-identity verification and the failed user-identity verification.

In accordance with another feature of the present invention, the secondary user authentication includes receiving and storing a digital image of the user, communicating the user's digital image to the merchant, displaying the user's digital image to a display associated with the merchant, visually comparing the user's digital image to a consumer's image to determine the at least one of the positive user-identity verification and the failed user-identity verification, and receiving, from the merchant, the at least one of the positive user-identity verification and the failed user-identity verification for the user-identity-verification indicator.

In accordance with a further feature of the present invention, the secondary user authentication includes receiving a social-media-user identifier from the user, engaging in a user-free electronic interaction with a social media account of the user using the social-media-user identifier, receiving a social-media-user-location identifier, receiving a transaction-location identifier, and comparing, through the identity verification agent, the social-media-user-location identifier and the transaction-location identifier to determine the at least one of the positive user-identity verification and the failed user-identity verification.

In accordance with another feature of the present invention, the secondary user authentication includes receiving a social-media-user identifier from the user, engaging in a user-free electronic interaction with a social media account of the user using the social-media-user identifier, compiling social media user data to determine a social-media-user-identity-verification score, and comparing, through the identity verification agent, the social-media-user-identity-verification score to a secured threshold value to determine the at least one of the positive user-identity verification and the failed user-identity verification.

In accordance with another feature of the present invention, the secondary user authentication includes receiving an authorized-transaction-location identifier from the user, receiving a transaction-location identifier, and comparing, through the identity verification agent, the authorized-transaction-location identifier and the transaction-location identifier to determine the at least one of the positive user-identity verification and the failed user-identity verification.

In accordance with another feature of the present invention, the secondary user authentication includes determining, through the identity verification agent, an authorized-transaction-location identifier based from a plurality of past-transaction-location identifiers, receiving a transaction-location identifier, and comparing, through the identity verification agent, the authorized-transaction-location identifier and the transaction-location identifier to determine the at least one of the positive user-identity verification and the failed user-identity verification.

In accordance with the present invention, a method for verifying a consumer's identity in connection with transaction involving a consumer and a merchant includes the steps of communicating a user-identifier from a user to a secured transaction server, communicating a unique mobile device identifier from a mobile electronic device associated with the user to the secured transaction server, associating the user-identifier and the unique mobile device identifier of the user to a user account residing on the secured transaction server, the secured transaction not operated by the merchant and including an identity verification agent, communicating a consumer identity verification request, from at least one of a mobile electronic device of the consumer and the merchant, to the secured transaction server, the at least one of the mobile electronic device of the consumer and the merchant being communicatively coupled, over a network to the secured transaction server, communicating a unique mobile device identifier associated with the mobile electronic device of the consumer to the secured transaction server, comparing, through the identity verification agent, the user's unique mobile device identifier and the consumer's unique mobile device identifier to determine at least one of a positive user-identity verification and a failed user-identity verification for a user-identity-verification indicator, and receiving the at least one of the positive user-identity verification and the failed user-identity verification.

In accordance with the present invention, a method for conducting a secured transaction with a merchant over a network includes receiving a user-identifier and a payment identifier from a user, receiving a unique mobile device identifier from a mobile electronic device associated with the user, associating the user-identifier and the unique mobile device identifier of the user to a user account residing on a secured transaction server, the secured transaction server not being operated by the merchant and including an identity verification agent, communicating an amount, associated with at least one purchase selection from the merchant, to a mobile electronic device of a consumer, receiving the amount, the payment identifier, and a unique mobile device identifier associated with the mobile electronic device of the consumer at the secured transaction server, comparing the user's unique mobile device identifier and the consumer's unique mobile device identifier, through the identity verification agent, to determine for a user-identity-verification indicator based on at least one of a positive user-identity verification and a failed user-identity verification, communicating the payment identifier and amount, upon determining the positive user-identity verification, to a financial institution server associated with the payment identifier, for payment of the amount, and relaying the amount to the merchant for payment of the at least one purchase selection.

In accordance with another feature, the present invention includes communicating the amount, associated with the at least one purchase selection from the merchant, to the mobile electronic device of the consumer located within a physical proximity of a point-of-sale terminal of the merchant.

In accordance with yet another feature, the present invention includes initiating a secondary user authentication upon determining the at least one of the positive user-identity verification and the failed user-identity verification, where the secondary user authentication includes receiving a user's biometric data at the secured transaction server, receiving a consumer's biometric data at the secured transaction server, and comparing, through the identity verification agent, the user's biometric data and the consumer's biometric data to determine the at least one of the positive user-identity verification and the failed user-identity verification.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. The terms “program,” “application,” “software application,” and the like as used herein, are defined as a sequence of instructions designed for execution on a computer system. A “program,” “computer program,” “application,” or “software application” may include a subroutine, a function, a procedure, an object method, an object implementation, an executable application, an applet, a servlet, a source code, an object code, a shared library/dynamic load library, and/or other sequence of instructions designed for execution on a computer system.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a block diagram of an exemplary distributed data processing network with a merchant, a secured transaction server, a mobile electronic device, and a financial institution in accordance with an embodiment of the present invention;

FIG. 2 is a block diagram of an alternative exemplary distributed data processing network in accordance with an embodiment of the present invention;

FIG. 3 is a block diagram of a data processing system that may be implemented as a network device, such as the secured transaction server shown in FIG. 1, in accordance with an embodiment of the present invention;

FIG. 4a is a process flow chart representing an exemplary method of conducting a secured transaction with a merchant over a network in accordance with the present invention;

FIG. 4b is a continuation flow chart of the exemplary process shown in FIG. 4, in accordance with the present invention;

FIG. 5 is a screenshot of an exemplary software application at least partially implementing the inventive process, the screenshot depicting a home screen on a user's electronic mobile device in accordance with an embodiment of the present invention;

FIG. 6 is a screenshot from the exemplary software application of FIG. 5 depicting a user interface displaying a user photo in accordance with an embodiment of the present invention;

FIG. 7 is a screenshot from the exemplary software application of FIG. 5 depicting a user interface operable to locate at least one merchant on the network in accordance with an embodiment of the present invention;

FIG. 8 is a screenshot from the exemplary software application of FIG. 5 depicting a map displaying at least one merchant on the network in accordance with an embodiment of the present invention;

FIGS. 9-10 are screenshots from the exemplary software application of FIG. 5 depicting the mobile device being operable to receive and decode information provided from a merchant in accordance with an embodiment of the present invention;

FIG. 11 is a process flow chart representing an exemplary method of authenticating a consumer during a merchant/consumer transaction in accordance with the present invention;

FIGS. 12-13 are screenshots from an exemplary software application depicting merchant-authentication interfaces in accordance with an embodiment of the present invention;

FIG. 14 is a screenshot from the exemplary software application of FIG. 5 depicting the consumer being prompted for a passcode in accordance with an embodiment of the present invention;

FIGS. 15-16 are screenshots from the exemplary software application of FIG. 5 depicting the consumer being notified of the consumer's mobile device being outside the range of a permissive use zone in accordance with an embodiment of the present invention;

FIG. 17 is a process flow chart representing an exemplary process of settling funds in a consumer/merchant financial transaction in accordance with an embodiment of the present invention;

FIGS. 18-19 are screenshots from an exemplary software application depicting merchant-transaction interfaces in accordance with an embodiment of the present invention; and

FIG. 20 is a process flow chart representing an exemplary process of utilizing a mobile-device-component identifier to verify a consumer's identity in accordance with an embodiment of the present invention.

### DETAILED DESCRIPTION

The present invention advantageously provides a method and device for conducting secured transactions with a merchant. The present invention may be used to verify a user's and/or consumer's identity in order to prevent fraudulent financial transactions, prevent fraud within the medical community, and other transactions where verifying the identity/authorization of the user is desired.

Although the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

Network

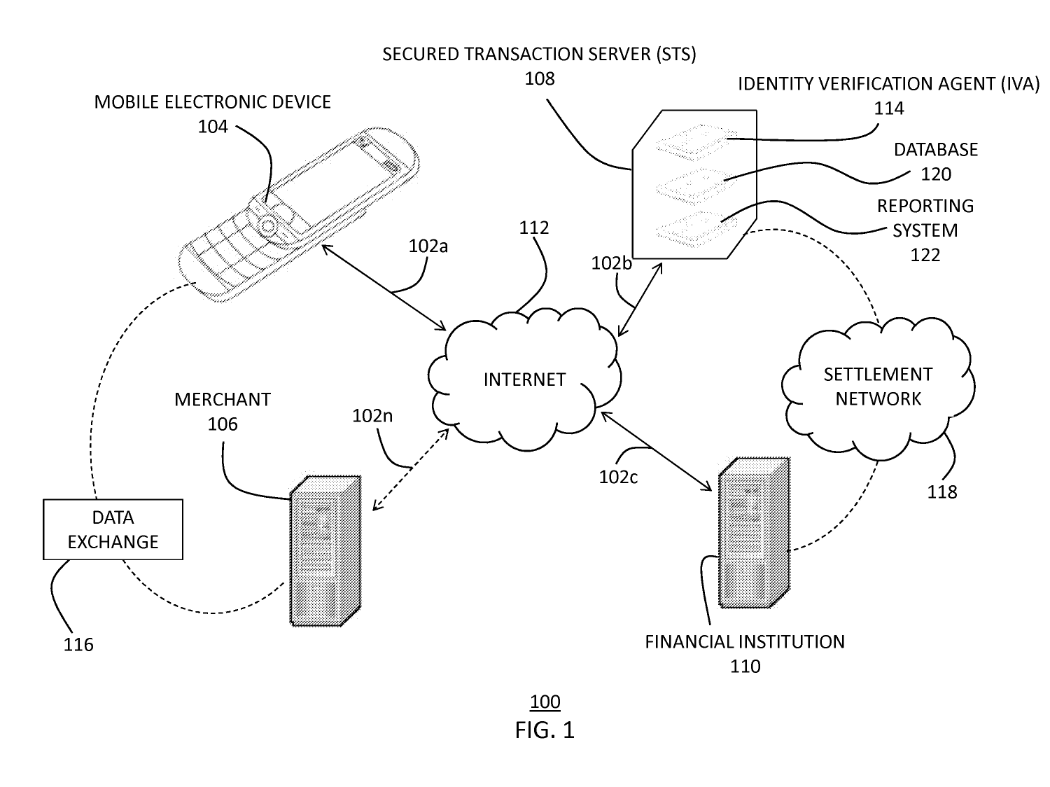

With reference now to FIG. 1, FIG. 1 depicts a representation of a network 100 of data processing systems in which the present invention may be implemented. The network 100 includes connections 102a-n, which are the medium used to provide communications links between various devices and computers connected together within the network 100. The connections 102a-n may be wired or wireless connections. A few exemplary wired connections are cable, phone line, and fiber optic. Exemplary wireless connections include radio frequency (RF) and infrared radiation (IR) transmission. Many other wired and wireless connections are known in the art and can be used with the present invention.

In the depicted example, the network includes a mobile electronic device 104, a merchant 106, a secured transaction server (STS) 108, and a financial institution 110. The merchant 106 may be directly connected to the network 100 in order to process a financial transaction or, in some embodiments, may not be connected to the network 100. The discretionary connectability of the merchant server 106 to the STS 108 or financial institution 110 is indicated by a hash-line arrow 102n. In embodiments where the merchant 106 is not directly connected to the network 100, the merchant 106 is communicatively coupled to the mobile electronic device 104 such that is may receive and transfer information, as described later herein. As referred to herein, the merchant 106 and financial institution server 110 represent a merchant and a financial institution, respectively, that operates or communicates through a merchant server 106 and financial institution server 110. Therefore, throughout the remainder of the specification, the merchant server 106 and financial institution server 110 will be referred to generally as the merchant 106 and financial institution 110, respectively.

In the depicted example, network 100 can include the Internet 112, which represents a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network 100 also may be implemented as a number of different types of networks, such as for example, an Intranet, a local area network (LAN), or a wide area network (WAN). FIG. 1 is intended as an example, and not as an architectural limitation for the present invention.

The secured transaction server 108 can be seen having an identity verification agent (IVA) 114 running on the STS 108, both of which are connected to the network 100. Again, it should be noted that the merchant server 106 is only exemplary and is not necessarily required in order for the present invention to be carried out. As stated above, the term “consumer” may be interchangeably used herein with the term “user,” depending on whether the actual/authorized user is purchasing products or services from the merchant, or whether it is an unauthorized person or entity purchasing the products or services.

The network 100 may include additional servers and other devices and entities not shown. In the depicted example, the mobile electronic device 104 communicates with the merchant 106 to receive an amount that is associated with at least one purchase selection from the merchant 106. This exchange is reflected in FIG. 1 as “data exchange 116.” As discussed herein, this data exchange 116 may occur through the Internet 112, or another wireless or wired data exchange method, e.g., Bluetooth, radio frequency identification (RFID), or near field communications (NFC). As will be explained in more detail below, the mobile electronic device 104 receives the amount from the merchant 106 and communicates the amount, along with other user-identifying information, to the STS 108 for the IVA 114 to confirm whether the consumer is authorized to make the transaction. Any of the depicted network entities, in addition to communication with each other over the network 100, are, in some embodiments, also able to communicate in a peer-to-peer relationship using wired or wireless links.

Once the IVA 114 has confirmed the identity of the consumer, whether it be with or without assistance from the merchant 106, the STS 108 may communicate over traditional financial transaction processing networks, which may include the Internet 112, to remove funds from the financial institution 110 and direct it to the merchant 106. In other embodiments, once the IVA 114 has confirmed identity of the consumer, the transfer of funds from the financial institution 110 to the merchant 106 may be initiated by the merchant 106. Devices and processes for transferring funds from the financial institution 110 to the merchant 106 are generally known by those skilled in the art. These processes, however, may include the merchant's server 106 or STS 108 communicating with a settlement network 118, e.g., Visa/MasterCard and an acquiring bank (or merchant bank).

Next, the settlement network 118, through the Visa/MasterCard, routes the transaction to the STS 108 which then forwards the authorization/denial codes to the merchant 106. If the transaction is approved, the products are exchanged between the merchant 106 and the consumer and the merchant 106, or merchant bank, batches out the authorization codes to the financial institution 110 for payment. Whether the authorization code is given directly from the financial institution 110 to the merchant 106 or is given from the financial institution 110 to the STS 108, and then to the merchant 106, the present invention advantageously facilities a secured financial transaction without the merchant 106 directly receiving the consumer's financial information. This process thereby minimizes the possibility of theft on the user by an unauthorized consumer and prevents theft by those associated with the merchant as the financial information is not stored with the merchant 106. In other embodiments, the settlement network 118 may communicate with one or more additional servers working alone, or in combination with, the STS 108 or merchant server 106.

The STS 108 is also operable to record information associated with the financial transaction on a database 120 associated with the STS 108. In addition, the STS 108 may be operable to report and receive information with other computing entities on or off the network 100 with a reporting system 122. The database 120 and reporting system 122 may be physically located on the STS 108, or may be located physically outside of the STS 108, but still communicatively coupled to the STS 108.

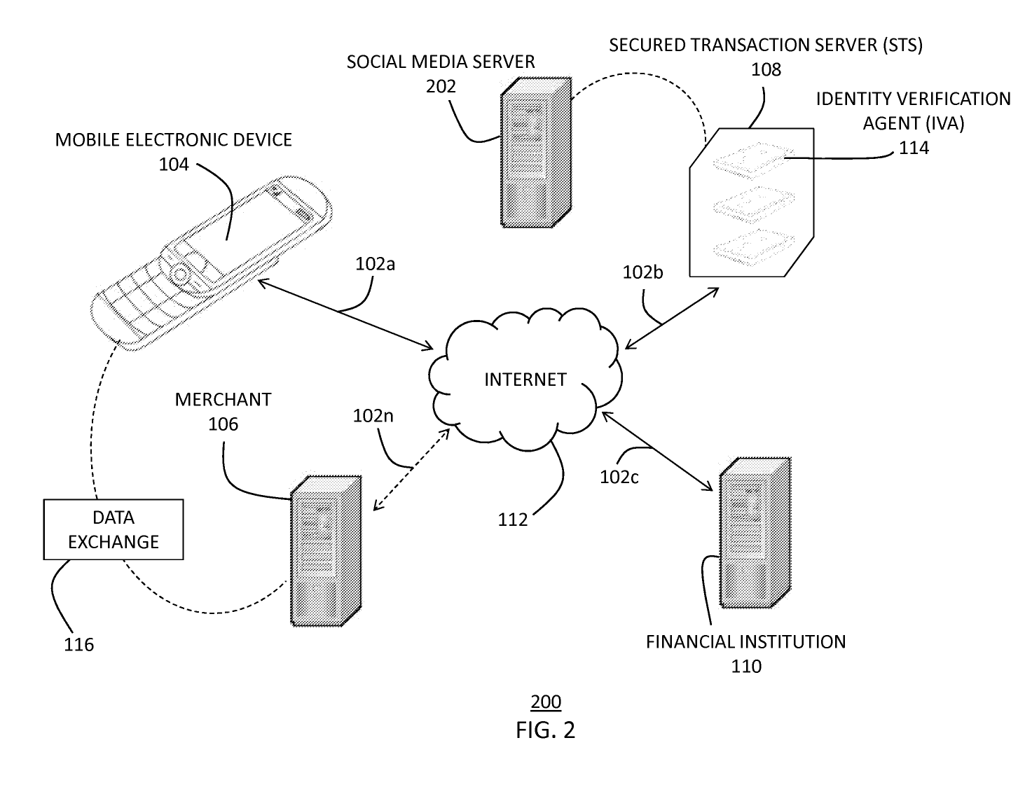

With reference now to FIG. 2, FIG. 2 illustrates another exemplary network 200 wherein a social media server 202 is communicatively coupled to the STS 108. As shown, the STS 108 is operable, through the IVA 114, to utilize one or more social media accounts, represented by the social media server 202, to verify a consumer's identity. As will be discussed in more detail below, the STS 108, through the IVA 114, analyzes the activity of a user on the social media account, the location of such activity, updates, etc., to determine whether there is a threat of fraud on the user. The computing entities located on the network 200 may then perform all, or some, of the above-described features of the network 100 shown in FIG. 1.

Server/Computer

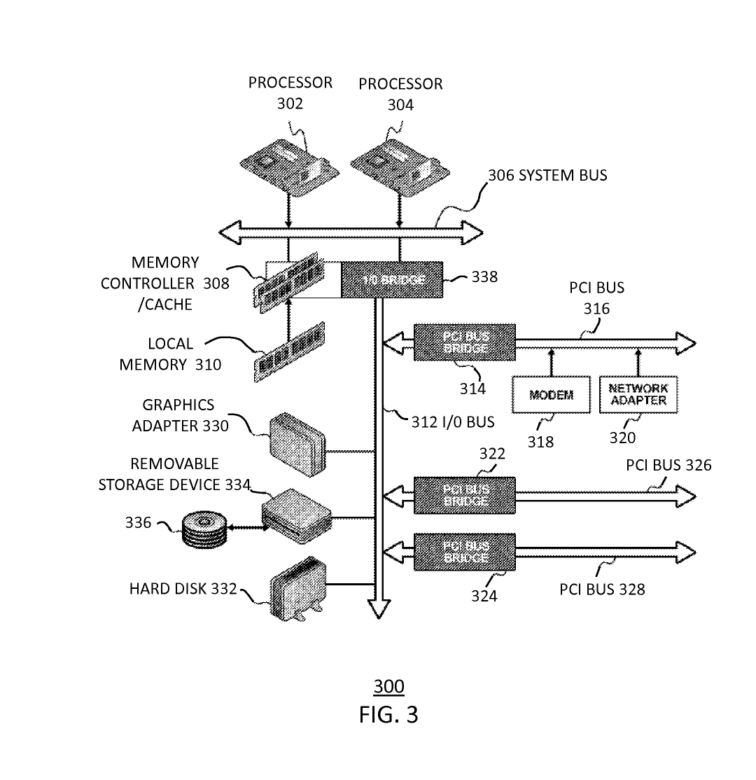

Referring to FIG. 3, a block diagram of a data processing system 300 that may be implemented as a server, such as servers 106, 108, 110, 202, or implemented as a personal computer or terminal/computer associated with such servers, as shown in FIGS. 1 and 2, in accordance with one embodiment of the present invention. The data processing system 300 may be a symmetric multiprocessor (SMP) system including a plurality of processors 302 and 304 connected to system bus 306. Alternatively, a single processor system may be employed. Also, connected to system bus 306 is memory controller/cache 308, which provides an interface to local memory 310. An I/O bus bridge 338 is connected to system bus 306 and provides an interface to I/O bus 312. The memory controller/cache 308 and I/O bus bridge 338 may be integrated as depicted. The processor 302 or 304 in conjunction with memory controller 308 controls what data is stored in memory 310. The processor 302 and/or 304 and memory controller 308 can serve as a data counter for counting the rate of data flow to the memory 310 or from the memory 310 and can also count the total volume of data accessed to or from the memory 310. The processor 302 or 304 can also work in conjunction with any other memory device or storage location.

Peripheral component interconnect (PCI) bus bridge 314 connected to I/O bus 312 provides an interface to PCI local bus 316. A number of modems 318, or wireless cards, may be connected to PCI bus 316. Typical PCI bus implementations will support four PCI expansion slots or add-in connectors. PCI includes, but is not necessarily limited to, PCI-X and PCI Express components. Communications links to the network of computers in FIGS. 1 and 2 may be provided through the modem 318 and network adapter 320 connected to PCI local bus 316 through add-in boards.

Additional PCI bus bridges 322 and 324 provide interfaces for additional PCI buses 326 and 328, from which additional modems or network adapters may be supported. In this manner, the data processing system 300 allows connections to a multiple network of computers. A graphics adapter 330 and hard disk 332 may also be connected to I/O bus 312 as depicted, either directly or indirectly.

Those of ordinary skill in the art will appreciate that the hardware depicted in FIG. 3 may vary. For example, other peripheral devices, such as optical disk drives and the like, also may be used in addition to or in place of the hardware depicted. The depicted example is not meant to imply architectural limitations with respect to the present invention.

The identify verification agent (IVA) 114 is explained in detail below and can be embodied in a computer program. Computer programs (also called computer control logic) are stored in memory such as main memory 310, removable storage drive 334, removable media 336, hard disk 332, and signals. Such computer programs, when executed, enable the computer system to perform the features of the present invention as discussed herein. In particular, the computer programs, when executed, enable the processor 302 and/or 304 to perform the features of the IVA 114.

In this document, the terms “computer program medium,” “computer usable medium,” and “computer readable medium” are used to generally refer to media such as main memory 310, removable storage drive 334, removable media 336, hard disk 332, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired or wireless network, that allows a computer to read such computer readable information.

The mobile electronic device 104 also includes a computing means, e.g., a processor, and a storing means, e.g., a memory. The processor is operable to run one or more programs/applications and interfaces associated with the mobile electronic device 104 or stored on the memory in order to effectuate the data transfer and communications required by the present invention. The mobile electronic device 104 may also have other components or features that include an accelerometer, a gyroscope, a GPS system, a proximity meter used to detect the proximity of the user to the mobile electronic device 104, an image capturing element configured to capture images and/or videos, an ambient light sensor configured to capture and ascertain lighting conditions, a microphone, or any additional element typically associated with the mobile electronic device 104 such as a phone.

As previously discussed, the merchant 106 may also include a terminal where financial transactions are carried out between the consumer and the merchant 106. The terminal may also include a storing means, e.g., memory, an ambient light sensor capable of sensing light conditions in the location surrounding or otherwise near to terminal, a network adapter that may include wired or wireless communications configured for communicating with the mobile electronic device 104, the STS 108, or the merchant server 106.

Prior to the Financial/Indentity-Verifying Transaction

The above-described hardware is useful for implementing the present invention, which facilitates a secure financial transaction between a consumer and a merchant 106 through the secured transaction server (STS) 108 and the identity verification agent (IVA) 114. As described herein, the STS 108 and the IVA 114 are utilized in connection with merchant transactions, but may also be applied to other transactions in the context of employee/employer relationships, patient/physician relations, among others. Specifically, the STS 108 provides security to the merchant 106, who can now verify and authorize the consumer before a purchase is made, and to the user, who can be assured fraudulent transaction will not derive from the user's financial information being stored with the merchant 106. As described herein, the inventive method may also be utilized to verifying a user's identity.

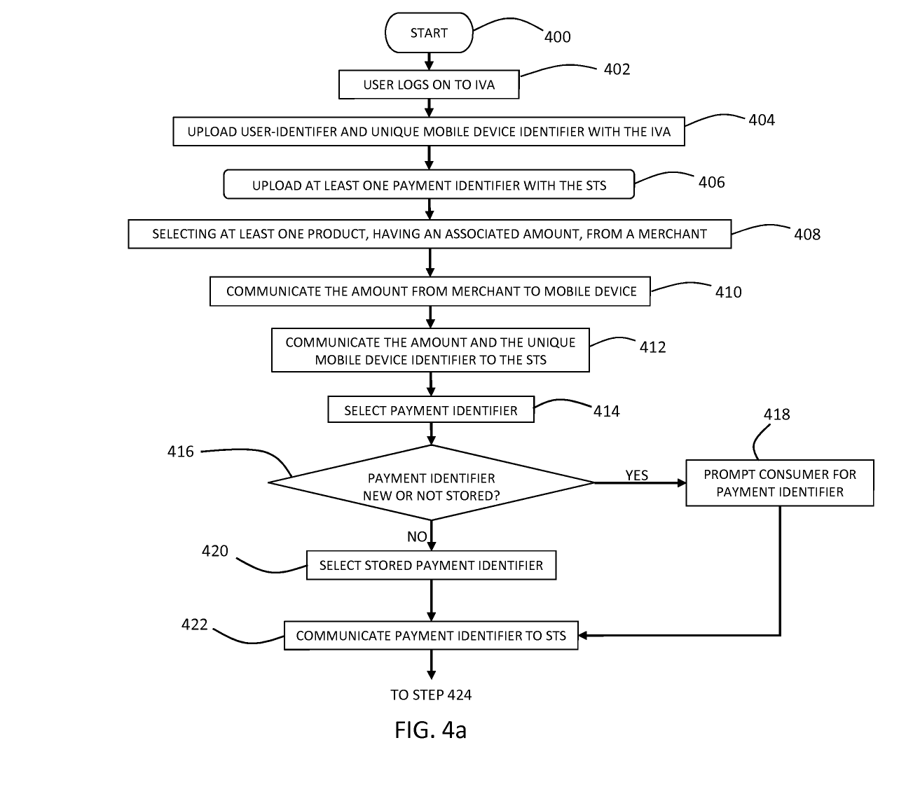

FIGS. 4a and 4b illustrate a single process flow of one embodiment of the present invention. The process flow provides exemplary steps for carrying out an exemplary embodiment of the present invention. The invention, however, is not limited to the number or order of steps shown in FIGS. 4a and 4b. The flow starts at step 400 and moves directly to step 402 where a user logs in to the IVA 114 through a network, such as the internet 112. It is noted that a user is not shown in FIG. 1; however, for the purposes of the instant discussion, a user and a consumer may be considered the same, unless the consumer is unauthorized. Web pages are well known in the art and are a resource of information that is suitable for access over the Internet 112 and can be accessed through a web browser running on a computing system, such the user's computer. Logging-in may also be accomplished through the user's mobile electronic device 104. Web pages may consist of files of static text stored within a server's file system (static web pages), or the web server may construct the (X)HTML for each web page when it is requested by a browser (dynamic web pages). Client-side scripting can make web pages more responsive to user input once in the client browser. Web pages are requested and served from web servers using Hypertext Transfer Protocol (HTTP). This information is usually in HTML or XHTML format, and may provide navigation to other web pages via hypertext links within the page. The web pages may also be used in combination with any kind of extensible markup language (XML) document, including plain XML, scalable vector graphics (SVG), and XML user interface language (XUL).

In other embodiments, the consumer may log into the network 100 utilizing a telephone network, wherein the user calls another individual or system connected to the network 100. The telephone network may include telephone lines, fiber-optic cables, microwaves, microwave transmission, cellular networks, and communication satellites. In such an embodiment, said log-in information may be transmitted over the telephone network where the individual, who may be on a LAN connection to the network, would input the information. In addition to this being carried out for the log-in process, it may also be implemented for any other step with the process flow diagram requiring a network connection.

In one embodiment, the user installs and launches a mobile application on the portable electronic device 104 that facilitates the log-in with the IVA 114. The user then uses the mobile electronic device 104 to upload a user-identifier with the IVA 114. This user-identifier may consist of a unique log-in user name or password. This may also include user-identifying information such the user's address, phone number, a photo of the user, biometric data, e.g., retinal/facial scan and fingerprints, and other user-identifying information. This user-identifying information may also be received and associated with any authorized persons desired by the user, e.g., a child/parent of the user. When the user uploads at least one piece of user-identifying information, a “user account” is created that resides on, or is otherwise accessible to, the STS 108 for future reference. This user-identifying information may be stored on the database 120 that is communicatively coupled to the IVA 114. In other embodiments, financial information of the user, e.g., credit/debit card information, may also be received by the STS 108 and stored on the database 120. Importantly, this database 120 and IVA 114 is not operated or maintained by the merchant 106. Therefore, the user's personal information is securely stored on a remote server which is symptomatic of most other known fraud prevention systems associated with merchant transactions.

As mentioned, the user's financial information may be stored and associated with a user account stored on the STS 108, as reflected in step 406 of the inventive process. This transfer of information may also occur through the mobile application, which permits the user to upload and store information such as a credit card, a debit card, banking account information, checking information, gift card information, or any other information for transacting a purchase. One or more pieces of this financial information may be referred to herein as a “payment identifier” and, more specifically, may also include the account numbers, card security codes (CSC) and other card verification data, expiration date(s), routing numbers, etc. In addition to being stored on the database 120 of the STS 108, the financial information and payment identifiers may also be stored locally with portable electronic device 104 or any cloud-based system. The financial information may be encrypted prior to storing or to transmitting across the network 100. The financial information is encrypted prior to storage in a database 120. Moreover, financial information relating to multiple accounts may also be stored in any or all of the described locations.

Before, during, or after the initial log-in with the IVA 114, the IVA 114 may receive a mobile electronic device identifier from the mobile electronic device 104 that is associated with the user or any other authorized persons. In other embodiments, the mobile electronic device identifier may be an electronic device identifier, i.e., a unique identifier from an electronic device that is not necessarily mobile. In the preferred embodiment, however, the unique electronic device identifier originates from what is known in the art as a “smart device,” or an electronic device that is cordless, mobile, connected to the above-described network, and capable of voice and video communication, Internet browsing, and providing a geographic location. This is reflected in step 404 of FIG. 4a. As the mobile electronic device 104 is used to initiate the financial transaction with the merchant, this advantageously gives the user and the merchant a baseline comparison parameter to verify the identity of the consumer, i.e., is the consumer authorized or unauthorized? In one embodiment, the mobile electronic device identifier is the only authentication protocol used by inventive fraud prevention process. In other embodiments, the mobile electronic device identifier may be used in combination with other authentication protocols.

The unique mobile device identifier permits the IVA 114 to determine whether portable electronic device 104 initiating the merchant/consumer transaction is the actual/authorized portable computing device 104, instead of a fraudulent device alleging to be the portable computing device 104. The unique identifier can be a piece of information that is generally only shared or associated with a limited number of mobile electronic devices 104. For example, the unique identifier can be the unique Wi-Fi address, media access control address (MAC), or extended unique identifier (EUI). These addresses may be administered to the mobile device 104 by its manufacturer (referred to as a “universally administered address”) or assigned/administered to the mobile device 104 by a network administrator (“locally administered addresses”), thereby overriding the universally administered address previously given to the device 104. The unique identifier may be used to alert the STS 108, through the IVA 114, of a fraudulent transaction if the mobile device identifier produced by the consumer during the financial transaction does not coincide with one of the mobile electronic device identifiers associated with the user. For example, a fraudulent device may attempt to submit a financial transaction between a merchant 106 and the consumer to the STS 108, claiming to be an authentic user; however, if the Wi-Fi or MAC address indicates that the fraudulent device is not the registered mobile device 104, but instead a desktop computer, then the STS 108 will alert the merchant 106 or simply deny the transaction. Included within step 404, in one embodiment, is the STS 108 associating the user-identifying information and the mobile device identifier with the user's account.

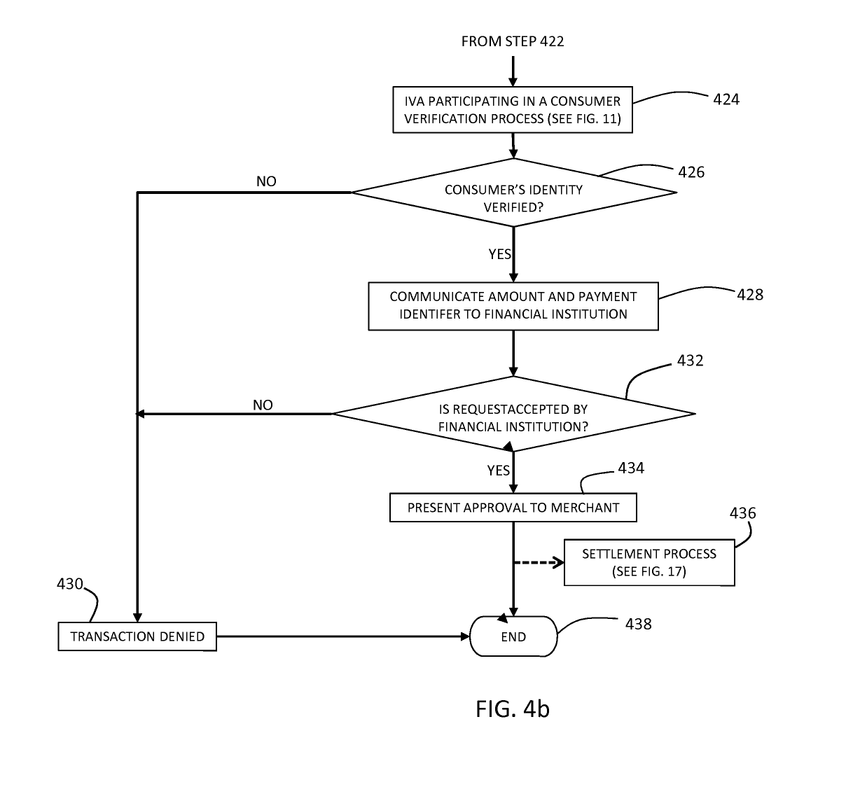

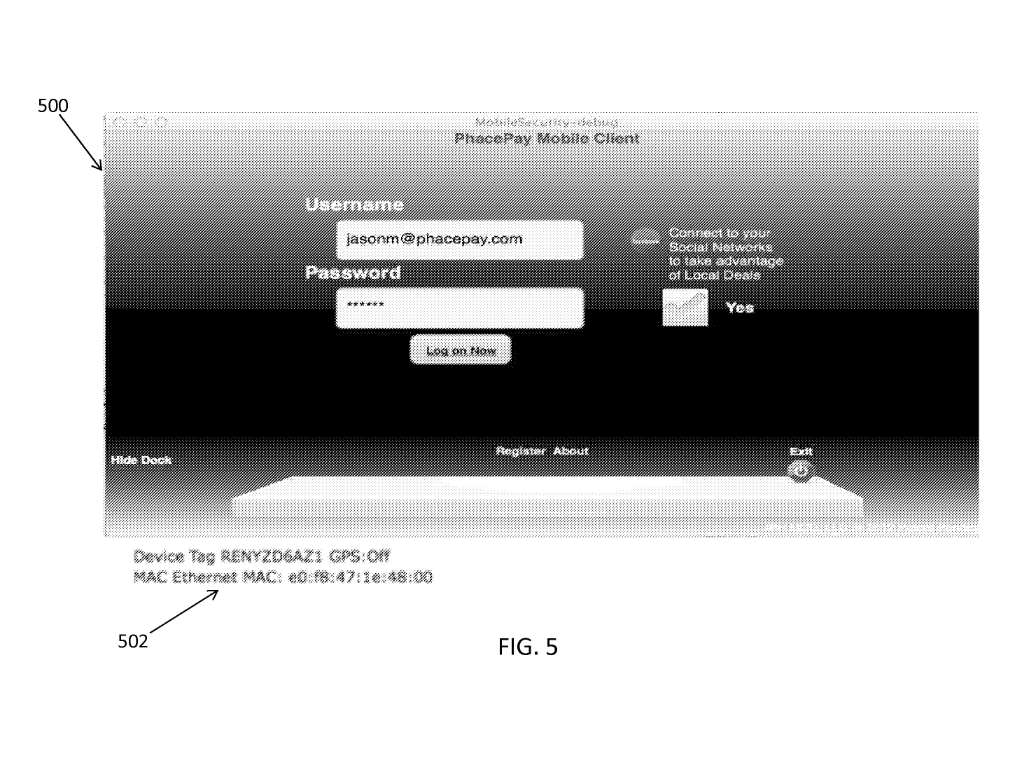

With reference now to FIGS. 5 and 6, FIG. 5 depicts an exemplary screenshot 500 representing the registration and log-in within step 404. As shown in FIG. 5, the mobile electronic device identifier associated with the user is shown in the lower left corner 502. Subsequent to creating a login, a user may interact with a user-interface of the STS 108, represented by the screenshot 600 of FIG. 6. This user interface/welcome screen 600 may include message(s), profile picture(s), advertisement(s), social media updates, news, and other information, as shown in FIG. 6. As discussed below, a user/consumer may desire to purchase a particular product in essentially two different ways. The first is a financial transaction with the merchant 106 wherein the consumer physically selects at least one product from the merchant 106. The second is a financial transaction with the merchant 106 wherein the consumer selects at least one product from the merchant 106 through the Internet or other means, typically through the computer application running on the user's mobile device 104.

In one embodiment, the consumer may be notified of all financial transactions associated with his or her account through messages 602 accessible from the user interface 600. The transaction messages include information relating to previous or real time transactions. For example, a transaction message may indicate that a photo of the user displayed at a merchant terminal and was confirmed by the merchant 106. Transaction messages provide the user/consumer with a detailed and/or summary of all financial transactions associated with the user's account. Conversely, in other embodiments, the merchant 106 may also have access to transaction messages relating to merchant transactions with a plurality of consumers.

The Financial Transaction—Receiving and Transferring Product Information from the Merchant to the Mobile Electronic Device

Now that the user has uploaded and stored the identifying information with the IVA 114, the user, who may be now considered a consumer, selects a merchant 106. This accomplished with the use of a mobile electronic device 104, such as a phone. With references to FIG. 4a, the next step 408 involves the consumer selecting at least one product from a merchant 106. After the consumer selects at one product, the inventive process follows to the step 410 of communicating an amount, which is associated with the at least one purchase selection from the merchant 106, to the mobile electronic device 104. The selection can include a product, commodity, a service, and the like that is offered by the particular merchant owning, operating, or otherwise associated with the merchant server 106.

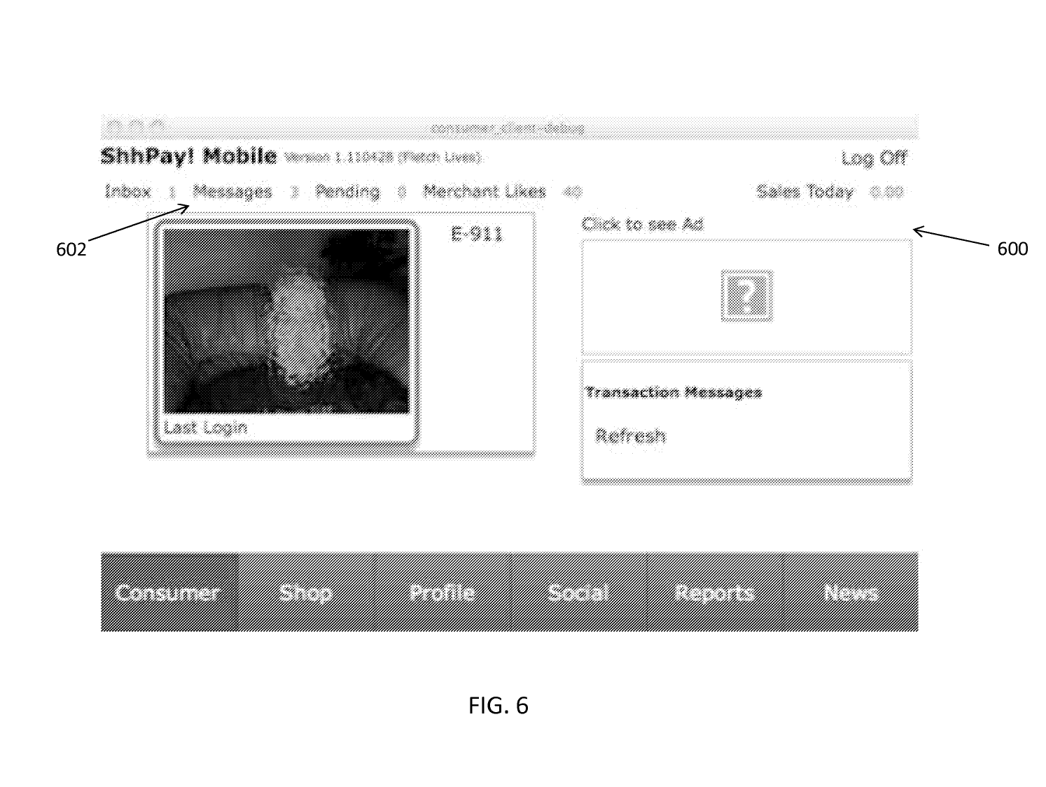

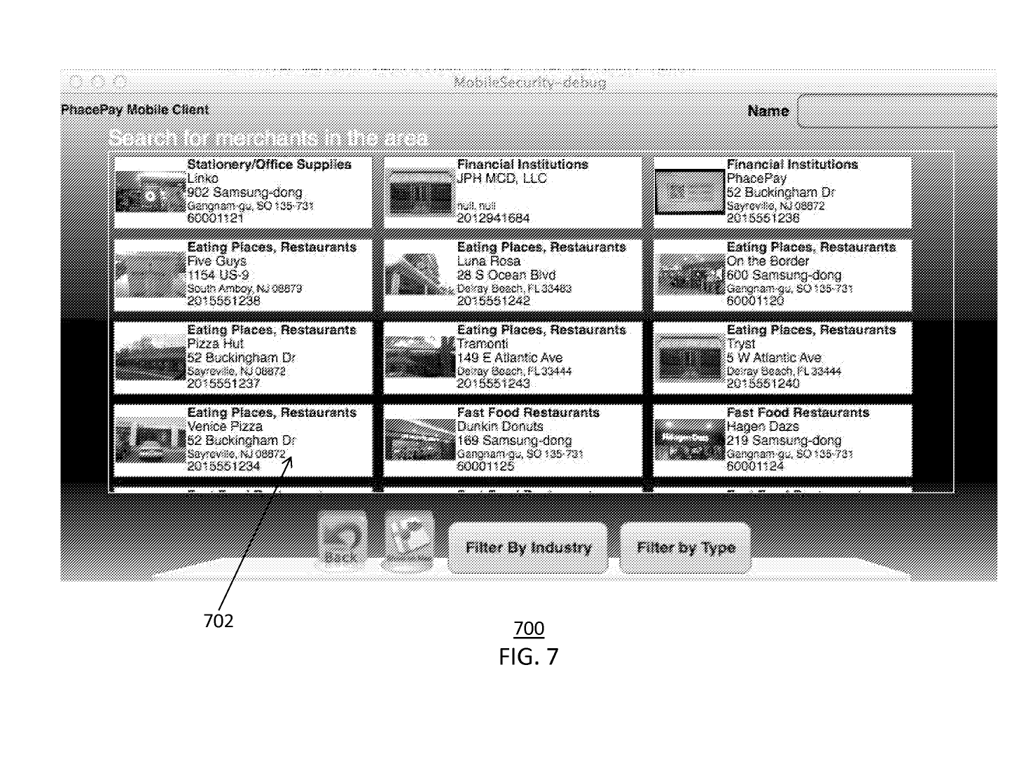

In one embodiment, the consumer may select a merchant 106 from the area in which consumer's mobile device 104 is located. FIGS. 7 and 8 depict screenshots 700, 800 from the exemplary consumer interface operated by an application residing on the consumer's mobile device 104. The application may also be web-based. Considering the location of the mobile electronic device 104, using, for example, known methods of cell tower triangulation, a map 802 shows merchants 106 capable of communicating with a consumer's phone, the STS 108, or otherwise connected with the network 100. In other embodiments, the consumer may select or browse one or more merchant(s) 702 in the area by using the phone's GPS. GPS or other known triangulation methods may be used to determine the consumer's location with respect to merchants 106 on the network 100. Selecting from a merchant 106 on the list or the map permits a consumer to initiate a purchase or other transaction, as further discussed herein and shown with the arrow 804.

As previously discussed, the financial transaction may be initiated within the merchant's physical location or may be initiated outside of the physical location of the merchant 106, i.e., through the Internet 112. In one embodiment, if the financial transaction is initiated outside of the merchant's 106 physical location, e.g., on-line, a consumer will add items desired to be purchased to a shopping cart. The cart may be an on-line virtual shopping cart. Alternatively, the client shopping in a brick and mortar store will produce the items at the checkout and the items will be scanned or otherwise tallied. Should the consumer purchase the products within the physical proximity of the point-of-sale terminal of the merchant 106, i.e., within the physical building of the merchant 106, the merchant 106 may also have software capable of communicating with the STS 108, more specifically the IVA 114. Alternative to, or in conjunction with, the software utilized by the merchant 106, the merchant 106 may also be able to access the STS 108 through a website on the Internet. The website permits the merchant to utilize the same or similar aspects as the software installed and ran locally with the merchant 106, e.g., on the merchant's server.

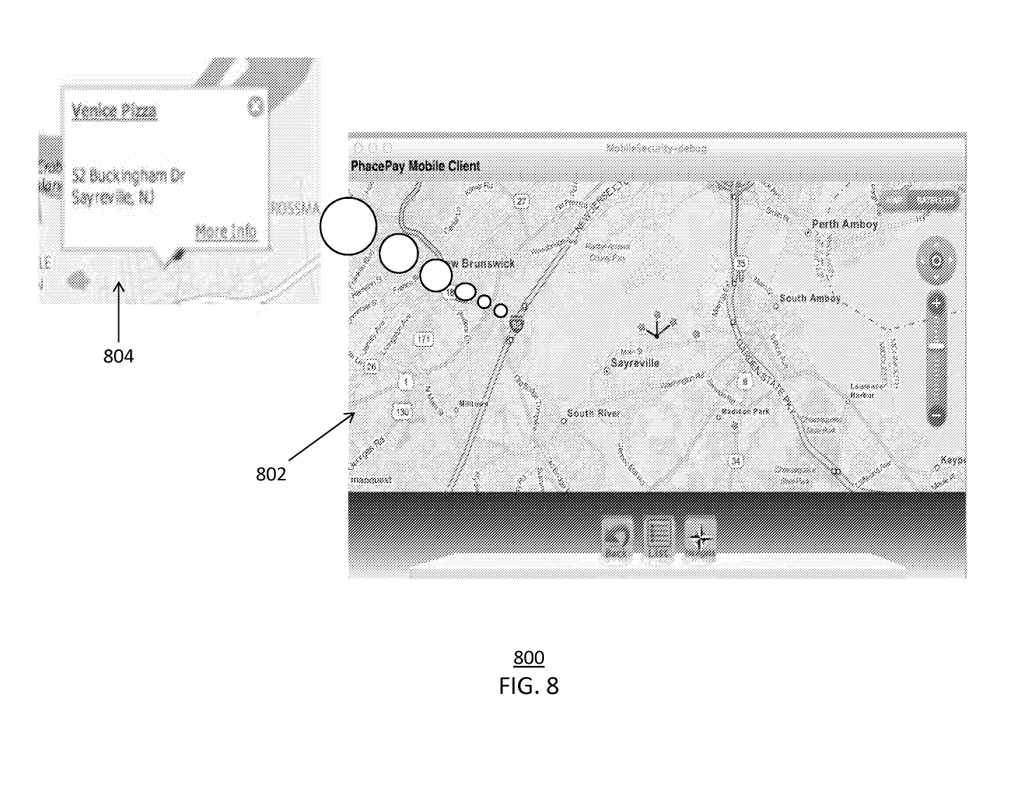

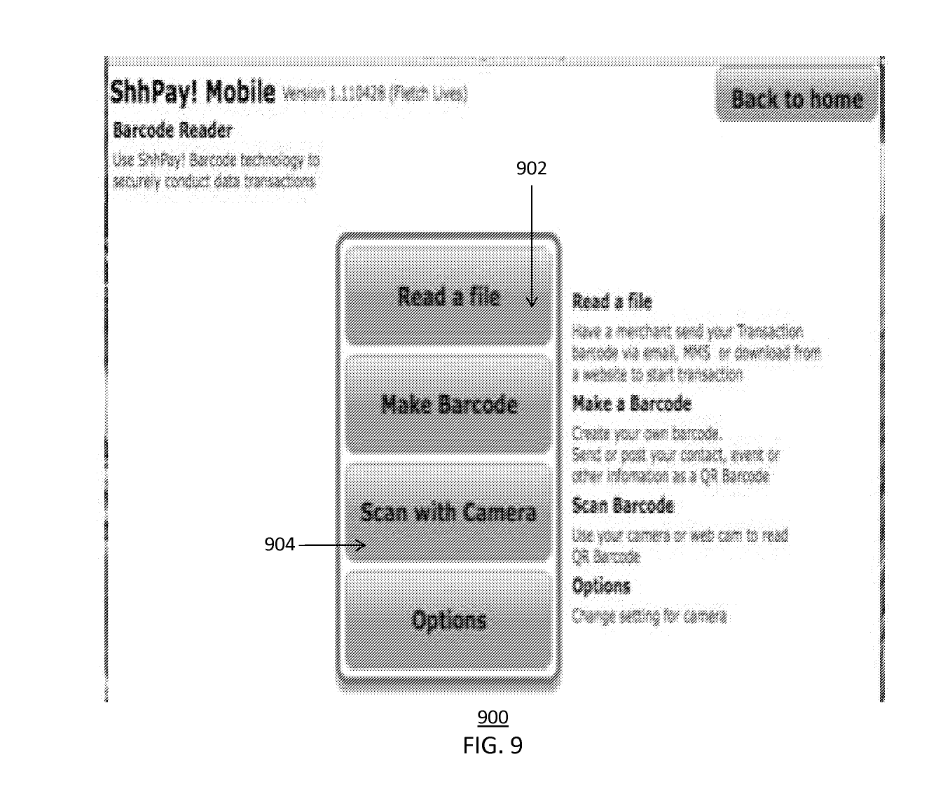

With reference to FIGS. 9 and 10, in one embodiment, after the merchant products have been tallied and the consumer desires to check out, a barcode 1002, or other computer readable medium, is generated by the merchant 106. FIGS. 9 and 10 represent screenshots 900, 1000 from an exemplary user interface operating on the consumer's mobile device 104. Again, the inventive method may be applied to electronic devices that are not, necessarily, mobile. In one example, the barcode 1002 is shown on a display associated with merchant server 106 and within the general physical proximity of the merchant terminal for the mobile device 104 to scan and read. In another example, barcode 1002 may be printed, stamped, impregnated or otherwise transferred to paper, plastic or any other substrate for the mobile device to scan and read. Furthermore, the computer readable medium may be transferred through Bluetooth or radio frequency (RF) transmitter, such as RFID, magnetic ink characters, wireless data transmission, and the like. Although the barcode 1002 is represented with a quick response (QR) code, the barcode 1002 may consist of a universal product code (UPC) or other computer readable medium.

The barcode 1002 may contain transaction information such as the total amount of the itemized goods and/or services, merchant account information and transaction identification data. For example, a consumer may receive the product identification data by reading a file (represented with the link 902) generated by the merchant 106. This information may be sent by e-mail, MMS, or downloaded from the Internet. The user interface may also permit the consumer to create a barcode consisting of the consumer's contact information, event information, or other data. The user-interface also permits the consumer to scan the barcode 1002 (represented with the link 904) generated by the merchant 106. As such, the mobile computing device 104 may also consist of a decoder or other software to interpret and read the barcode 1002. In other embodiments, the mobile device 104 communicates the barcode 1002 to the STS 108 for decoding. In additional embodiments, the information contained within the barcode 1002 is displayed directly on the mobile device 104 (shown in FIG. 10).

With reference back to FIG. 4a, after the step 410 of communicating the product information to the mobile device 104, the next step 412 includes the consumer selecting a payment identifier, e.g., a credit card number. Step 416 includes the STS 108 querying whether the payment identifier is stored on the STS 108 or whether the consumer would like to insert a new payment identifier. This advantageously prevents the merchant 106 from receiving and storing the financial information of a consumer. If the answer to the query is yes, step 418 includes prompting the consumer, through the software application operating on the mobile device for example, for a payment identifier. If the answer to the query is no, step 420 includes the consumer selecting a stored payment identifier stored on the database 120. The process continues to step 422 of communicating the payment identifier to the STS 108. In other embodiments, step 412 may also be included within step 422, such that the payment identifier, a unique mobile device identifier, and the amount are sent to the STS 108. The payment identifier, unique mobile device identifier, and amount may all be considered a means to initiate, what may be referred to herein as, a “consumer identity verification request.” The consumer identity verification request may take the form of any other piece(s) of information received by the STS 108. In other embodiments, the amount of the product selected by the consumer is not communicated to the mobile device 104, but rather the consumer inserts an amount (typically an amount sufficient to cover the price of the selected goods) that is then communicated to the STS 108. In other embodiments, the consumer may also select a currency for the transaction based on the most valuable exchange rate and other factors. It should be also noted that the payment identifier request may also occur after the consumer's identity has been confirmed by the IVA 114.

The Financial Transaction—the Identity Verification Agent

The STS 108 is a physical hardware device having some or most of the above-described features and components for hardware/computers. The identity verification agent (IVA) 114 can be hardware and/or a computer program that is responsible for accepting HTTP requests from a consumer and serving them HTTP responses along with optional data contents, which usually are web pages such as HTML documents and linked objects (images, etc.). The IVA 114 may also be configured to accept HTTP requests from a merchant 106, mobile device 104, or other processing servers, in addition to also serving those servers with HTTP responses along with optional data contents. The STS 108 or IVA 114 may also receive, through the merchant's on-line application, payment details, such as order number, amount, and others information. In addition, the IVA 114 may receive, interpret, and send information from/to the mobile device 104 and/or merchant 106.

Although the STS 108 has been referred to as having the IVA 114 and database 120 within the same server, it is contemplated that the IVA 114 and database 120 may each reside in other servers, such as cloud-based storage or other locations. Moreover, the IVA 114 may also at least partially reside on the mobile device 104 of the consumer. In an exemplary implementation, the IVA 114 may include the following functionalities:

Programming interface for mobile electronic device

Receive and interpret consumer identification data

Mechanism for comparing consumer/user identification data

Programming interface for on-line fund transfer service

Carry out and relay authentication protocols and acceptance/denials

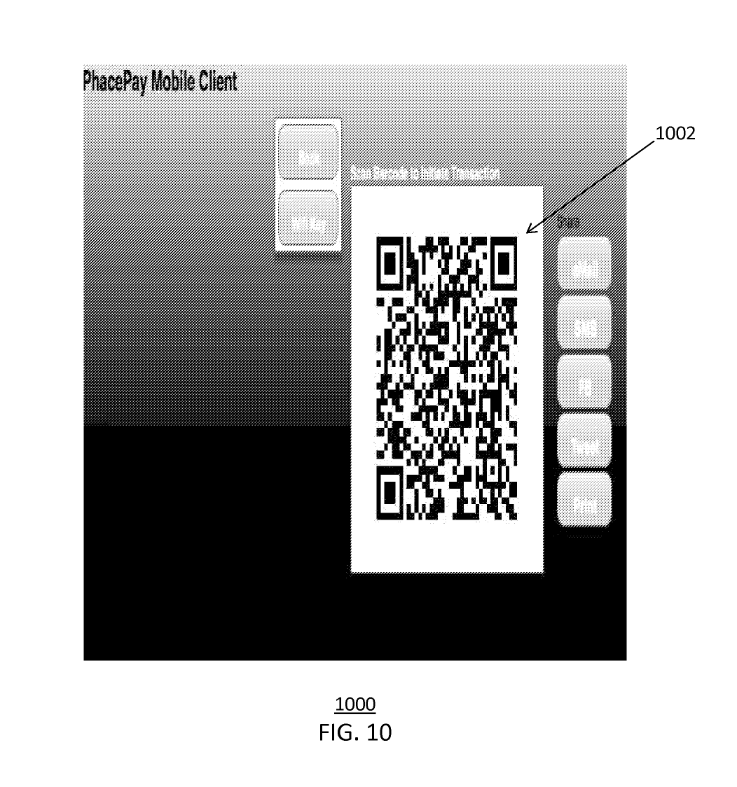

With reference to FIG. 4b, after the step 422 of communicating the payment identifier to the STS 108, the process continues to the step 424, or the identity verification agent (IVA) 114 engaging in the verification process, thereby comparing the information generated by the user with the information generated by the consumer. This verification process is shown in more detail in FIG. 11. As this financial transaction is initiated, at least partially, with the mobile device, in one exemplary embodiment, the IVA 114 compares the unique mobile device identifier, e.g., MAC address, of the user (including authorized users) to the unique mobile device identifier of the consumer. As such, this comparison is included within step 424 of the inventive process. In other embodiments, the unique mobile identifiers may be unique electronic identifiers that originate from electronic devices of both the user and consumer that are not, necessarily, mobile.

After step 424, the process continues to step 426 wherein the IVA 114 determines whether the consumer's identity has been authenticated. If the consumer's identity has been verified (also referred to as a “positive user-identity verification”), the process continues to step 428 of communicating the payment identifier selected by the user and the amount (representing the at least one purchase selection) to the financial institution 110 for payment. As described below, the payment identifier, e.g., credit card number, is associated with the financial institution server 110 such that the payment identifier at least partially enables the financial institution to process the financial transaction. As security and authentication protocols of financial institutions continually increase and change, the financial institution may require other information to carry out the financial transaction. If the IVA 114 determines that the consumer's identity has not been verified (also referred to as a “failed user-identity verification”), the process follows to the step 430 of denying the financial transaction. In other embodiments, after either the positive or failed user-identity verification has been determined, an approval or denial is communicated to the merchant 106 who then participates in a settlement process with the financial institution or informs the consumer that the transaction has been denied. The end result from either obtaining either a positive or a failed user-identity verification may also be referred to herein as a “user-identity-verification indicator.”

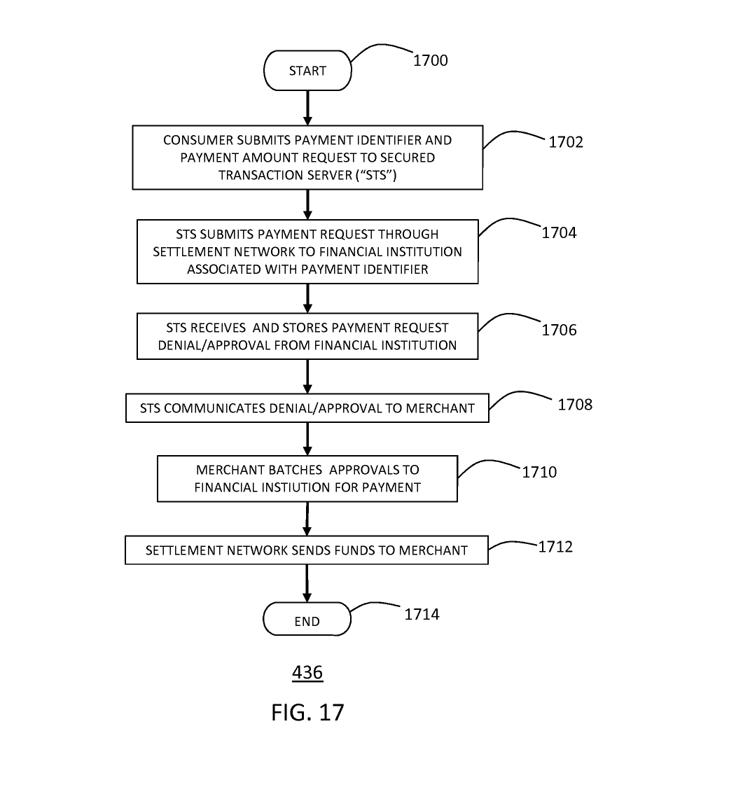

In step 432, should the payment request be derived from the STS 108 or IVA 114, the IVA 114 will interpret the financial institution's 110 response(s) to determine whether the transaction has been successfully processed. If the payment is not accepted by the financial institution 110, the flow moves to step 430 where an error page or transaction denial is presented to either the consumer and/or the merchant 106. The STS 108 is also operable to send an indication of the failed request to another server or device connected to the network 100, or otherwise communicatively coupled to the STS 108. If the payment request is accepted by the financial institution 110, step 434 includes a summary page or approval being communicated from the STS 108 to the merchant 106 or consumer. The summary page details the transaction and provides the merchant 106 or consumer with a record of the transaction and may be done through a reporting system 122 (shown in FIG. 1) residing on the STS 108. In other embodiments, the IVA 114 may also be operable to send a record of the transaction, including approval. The summary page may also be emailed to the consumer using an email address that the consumer provided during the log-in process or stored on the database 120 for the user/consumer to view. After the financial transaction has been approved, the settlement process, or the transfer of funds (i.e., the amount) from the financial institution 110 to the merchant 106 may occur in step 436. An exemplary settlement process is shown in FIG. 17. The process then ends at 438.

It should be noted that, in other embodiments, the inventive consumer verification process 424 may be utilized without employing steps 406, 408, 410, 414-422, 428, 432, and 438. In said embodiments, the present invention may be incorporated in a consumer/merchant transaction that does not involve the payment or transfer of money, or any other monetary indicia. Such embodiments include, at least in part, using the IVA 114 to confirm a patient's identity in a patient/physician relationship in order to obtain medical records, to confirm an employee's identity in employee/employer relationship in order to obtain access to confidential information or locations within an employer's facility, or to confirm a tenant's identity in a landlord/tenant relationship in order to obtain access to the dwelling.

With reference now to FIG. 11, FIG. 11 depicts a process flow diagram representing an exemplary authentication process carried out by the IVA 114, as shown in step 424 of FIG. 4b. Although the consumer authentication process may come before the payment request is sent to the financial institution, in other embodiments, the payment request may occur contemporaneously with or after the payment request. Furthermore, one or more of the exemplary steps may be used individually to authenticate the consumer, or may be used in combination with other steps, parameters, or protocols disclosed herein.

The process starts at step 1100 and then immediately flows to step 1102, which, in one inventive authentication protocol, includes receiving the unique mobile device identifier from the consumer, e.g., the MAC address. Step 1104 includes comparing the consumer's mobile device identifier with the user's mobile device identifier. Step 1106 includes querying, through the IVA 114 for example, whether the consumer's and user's mobile device identifier match with one another. This allows the STS 108 to verify whether the mobile electronic device 104 utilized for the financial transaction is authorized or unauthorized in accordance with the user's preference. For example, a consumer making a financial transaction with a merchant from a desktop computer would certainly be flagged by the IVA 114 as the identifier would not correspond with a mobile device 104.

In additional embodiments, the IVA 114 may also authenticate a consumer by determining what components or features, e.g., an accelerometer, a gyroscope, a GPS system, a proximity meter, an image capture element, etc., are residing on the mobile device of the consumer. These components may be referred to in their collective, or independently, as mobile-device-component identifier(s). The IVA 114 will then compare this information to the information given to the IVA 114 at initial log in for one or more users. Of course, the user's information may also be updated (including adding additional authorized users) after the initial login. Again, if the IVA 114 determines that consumer's and user's information correspond (i.e., substantially identical) the process continues to step 1108, or the consumer's identity being authenticated. In other embodiments, the IVA 114 may verify a consumer's identity if the consumer's and user's information are not substantially identical but close enough to warrant an authorization, e.g., one or two digits of the consumer's MAC address do not match with the user's stored MAC address. Alternatively, the IVA 114 may also be operable to verify whether the consumer's device is portable or not. In those instances where the user only registers a desktop computer, for example, the consumer's use of a mobile electronic device, such as a phone, will prevent the consumer from being authenticated by the IVA 114.

In one embodiment, should the consumer's and user's information not correspond or not match with one another, step 1110 includes querying, through the IVA 114 for example, whether there are any secondary authentication protocols. In one embodiment, the process may utilize one authentication protocol, i.e., step 1104, to verify the identity of the consumer. In such case, the process continues to step 1112 of not authenticating the identity of the consumer. In other embodiments, the IVA 114 may utilize other authentication protocols to determine a positive user-identity verification. As previously stated, one or more of these authentication protocols may be used singularly, in combination with one another, and in any order to consequently generate a positive or failed user-identity verification.

One such secondary authentication protocol (also referred to as a secondary user authentication), shown in step 1114, includes the IVA 114, upon receiving the amount and payment identifier, displaying a digital image of the registered/authorized user associated with the mobile device to one or more displays within the physical proximity of the point-of-sale (POS) terminal. The term “physical proximity” is defined to be a distal radius from the POS terminal (or other referenced object/location) where an agent or other representative of the merchant 106 can visually see the consumer. This digital image, which essentially is a physical likeness or representation of the user, allows the merchant 106 to actively confirm the identity of the user before the transaction is approved without any financial information actually exchanging between the merchant and the consumer. Following the process out, step 1128 includes comparing the consumer response to the user response data. In the present situation, the consumer response is the consumer's visual appearance wherein the stored user response data is the image of the registered/authorized user.

In other embodiments, as discussed below, the consumer may be required to submit his or her biometric data, e.g., facial characteristics, retinal scan, fingerprints, for comparison to all authorized users. The consumer may also be required to submit additional verifying information that is indirectly associated with the consumer, e.g., the consumer's unique mobile device identifier, GPS location. After the consumer's and user's information is compared, step 1130 includes determining whether the consumer's and user's information correspond. If the submitted information/data does correspond, the process continues back to step 1108 of confirming the consumer's identity. If it does not correspond, the process continues to step 1112 of not confirming the consumer's identity and then immediately proceeding to step 1132 of terminating the identification process. In alternative embodiments, the process may continue back to step 1110 of obtaining secondary (or a “third” layer of authentication, depending on the number of iterations). This optional authentication is represented by the hash line 1126.

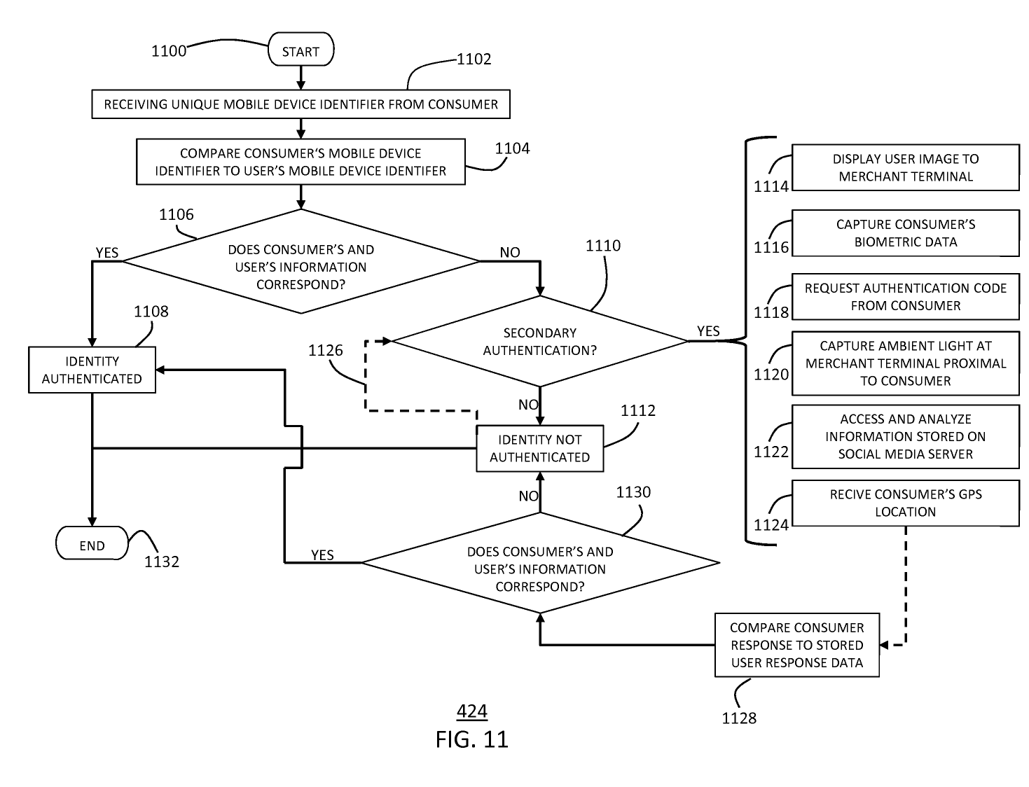

FIG. 12 is a screenshot 1200 of an exemplary application running on a server associated with the merchant 106. As shown, once the STS 108 receives a payment/identity verification request, the IVA 114 will cause an image 1202 of the user to display. This image 1202 will allow visual confirmation by an agent/representative of the merchant 106. Opposed to those known fraud prevention systems, the present invention requires an active verification by the agent/representative of the merchant before the financial transaction can be carried out. Therefore, the agent/representative will either confirm or deny the identity of the consumer. Again, if the clerk confirms the identity the transaction may continue. If the clerk denies the identity, the transaction will be refused by the IVA 114, STS 108, or both. Additionally, the address, along with other identifying parameters, of the consumer may also be confirmed (represented by the link 1204).

In other embodiments, the process 424 includes step 1116 of capturing the consumer's biometric data. One example includes prompting the consumer for voice identification data. This voice identification data may be taken from a microphone associated with the mobile device 104 or a device associated with the merchant 106. The voice identification data, e.g., audio signal, may then be converted from an analog wave to a digital fingerprint of the consumer's voice. This digital data may then be compared to the registered/authorized user sample taken at registration (or some time thereafter). If the consumer's voice identifier matches or corresponds to the stored user identifier, the STS 108, or IVA 114, may authorize the transaction. Again, if there is no match, identity verification is denied. As biometric data is generally difficult to imitate, the potential for fraudulent transactions is reduced, substantially benefiting both the merchant and user. In some instances, the IVA 114 may also be programmable to progressively store and adapt to any changes in the user's voice over a period of time.

Other biometric data that may be captured from consumer includes a retinal scan of the consumer's retina (using the camera of the mobile electronic device 104 for example), a fingerprint of the consumer (using the screen of the mobile electronic device 104 for example), among other biometric identifiers.

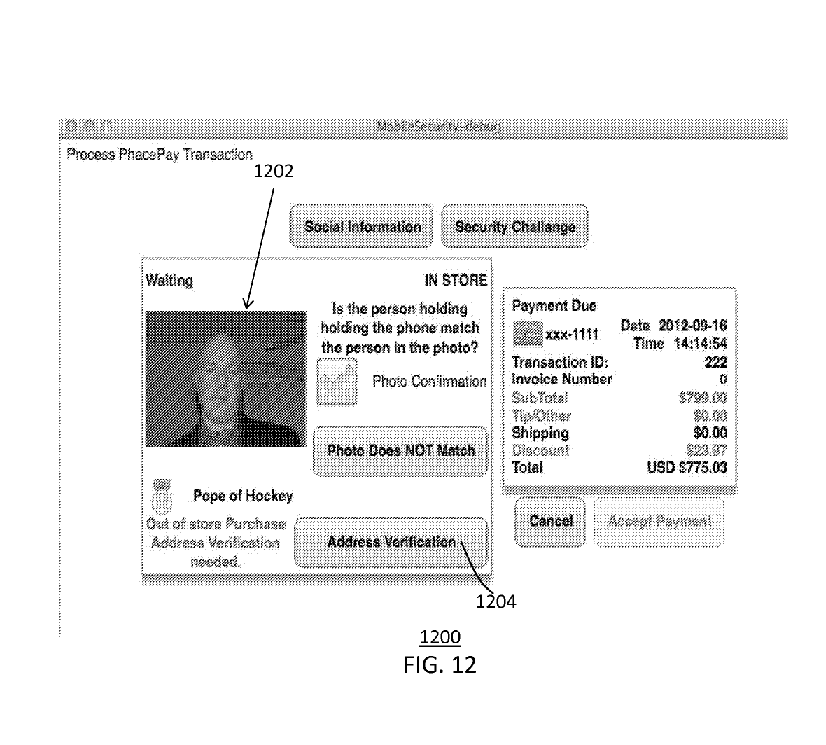

Another biometric authentication protocol includes capturing an image of the consumer's face. With reference to FIG. 13, a screenshot 1300 of an interface generated by the exemplary software implementing this feature is shown. Although this may be accomplished by the mobile device 104 of the consumer, an image may also be captured by a camera associated with, or located within the physical proximity of, the POS terminal of the merchant 106. In one embodiment, the image is captured and communicated to the IVA 114 for facial recognition, based on a stored set of facial data values for an authorized user. As methods and devices for determining facial data values from a person is known in the art, a detailed description will not be done. In other embodiments, the merchant 106, through software including the 114, may carry out the facial comparison between the user and the consumer. In other embodiments, the image is communicated to the secured transaction server 108 for analysis by the IVA 114. The comparison option is shown on the exemplary interface with the link 1302. In further embodiments, the IVA 114 may be operable to read images associated or available on one or more social media servers 202 and compare those facial data values to those of the consumer.

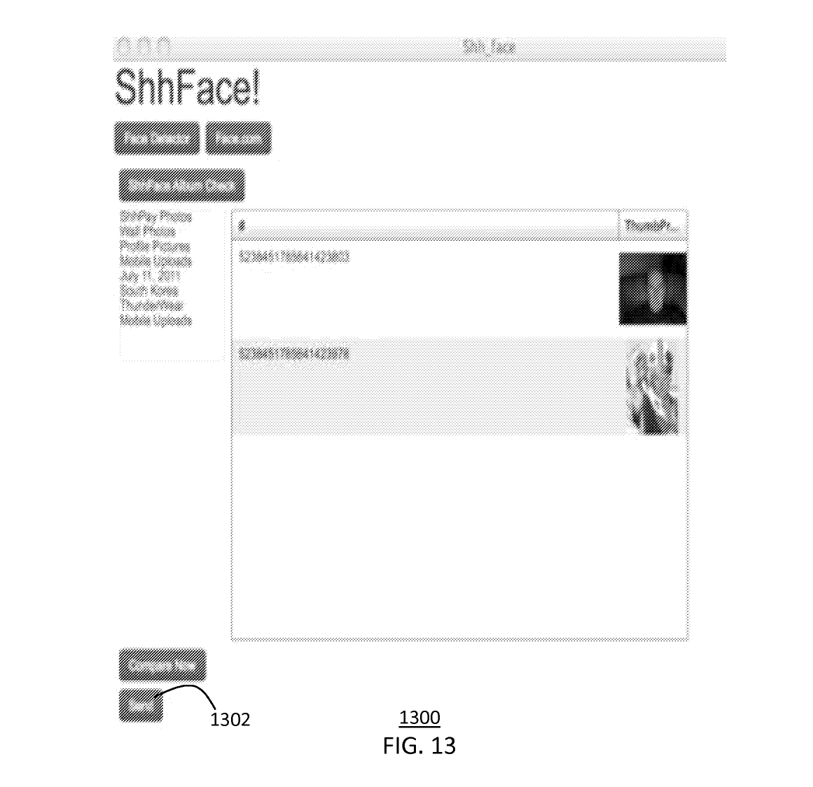

In further embodiments, the process 424 includes the authentication step 1118 of requesting an authentication passcode, or “code” from the consumer. This code may be inputted by the consumer at the POS terminal or on an interface generated by the exemplary application running on the consumer's mobile device 104. This code may be provided by the user at initial registration, or at some point thereafter. The code may represent an individual authorized user or a group of authorized users. With reference to FIG. 14, a screenshot 1400 of a consumer prompt is shown. This prompt queries the consumer for the PIN, which advantageously prevents those unauthorized users from completing the financial transaction. Moreover, although this prompt is preferred to occur before payment has been authorized, this prompt may also occur after the transaction has been approved by the user's financial institution 110.

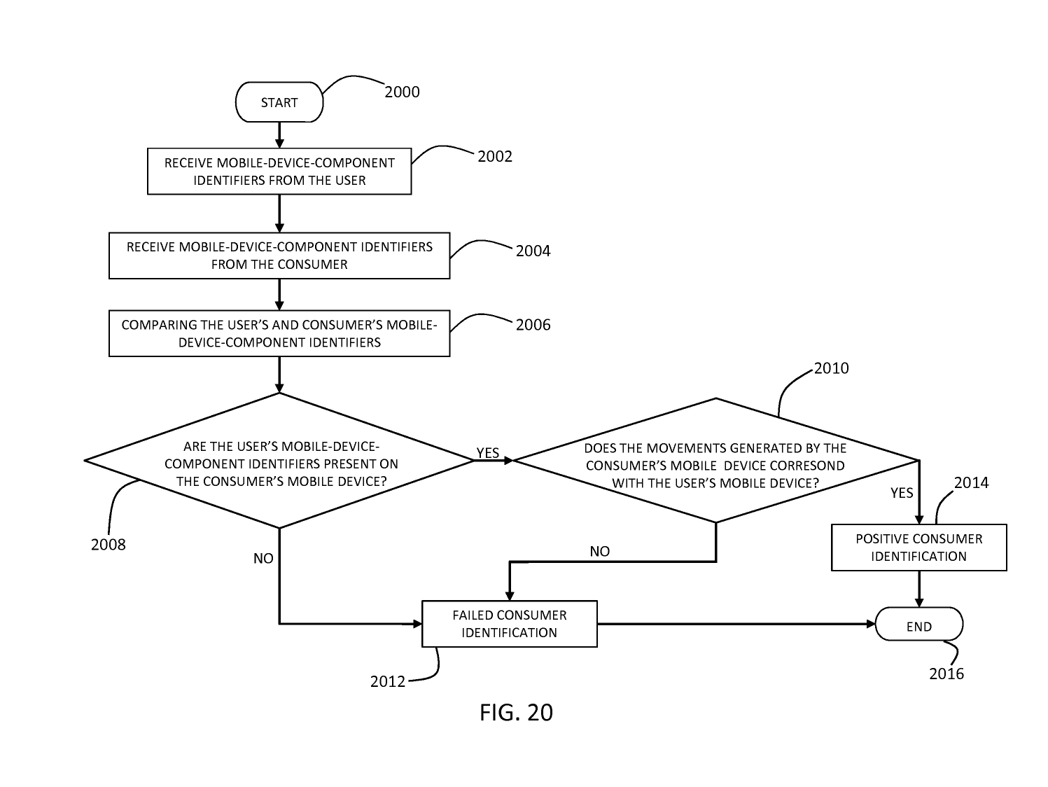

In further embodiments, the consumer may be authenticated using the aforementioned mobile-device-component identifiers of both the user's, and consumer's, mobile device 104. These mobile-device-component identifiers may include features or characteristics specifically associated with a particular mobile device 104, such as an accelerometer, gyroscope, ambient light sensor, camera, and flash, among others. The accelerometer measures multi-axis acceleration of movement values in the X, Y and Z direction. The gyroscope is utilized to measure or sense rotation or twist, i.e., angular rotational velocity, of the mobile device 104. With brief reference to FIG. 20, an exemplary process of authenticating a consumer based on mobile-device-component identifiers is shown.

The process starts at step 2000 and then immediately proceeds to step 2002. Step 2002 includes receiving a plurality of mobile-device-component identifiers from a user's mobile electronic device 104. Step 2002 also includes receiving mobile-device-component identifiers from any authorized mobile phones associated with the user's account, e.g., a parent's and child's mobile phone. These mobile-device-component identifiers are typically acquired at the initial registration and then may be stored on the STS 108 for use by the IVA 114. After the STS 108 has received the identity verification or payment request, step 2004 includes capturing, through the IVA 114, the mobile-device-component identifiers from the mobile device 104 of the consumer associated with the transaction. The mobile-device-component identifiers of the consumer's mobile device 104 are received by the STS 108 and, in step 2006, are compared to each other.

Step 2008 includes querying whether the user's mobile-device-component identifiers are present on the consumer's mobile device. For example, if the mobile device 104 of the consumer included an accelerometer and an ambient light sensor the IVA 114 may determine whether the consumer's mobile device 104 includes those components. If the answer is no, the process proceeds to step 2012 of a failed consumer identification. The process would then conclude at step 2016. In one embodiment, should the answer to the query of step 2008 be yes, the process proceeds to step 2010 of querying whether the movements generated by the consumer's mobile device 104 correspond with the user's mobile device 104, specifically the movements produced by the one or more mobile-device-component identifiers of the user's mobile device 104. For example, the IVA 114 may capture movements, i.e., in the X and Y directions, from the accelerometer of the consumer's mobile device 104. If the accelerometer on the user's mobile device 104 has values in the X, Y, and Z directions, then the movements do not correspond with one another. The same may apply with respect to the certain ambience readings from the mobile devices 104 of the user and consumer.

The readings from the mobile device 104 may be converted into an encrypted hash function before it is communicated to the STS 108. The encrypted hash function takes the data received from the consumer's mobile device 104 and returns a fixed-size bit string that is decrypted when it reaches the STS 108. In other embodiments, the data from the consumer's mobile device may be converted and transferred using other indexing methods. If the answer to step 2010 is no, the process follows to step 2012, of a failed identification, and ultimately ends at step 2016. If the answer to step 2010 is yes, the process continues to step 2014 of rendering a positive consumer identification. The process ends at 2016.

Another authentication protocol includes, within step 1120, capturing the amount of light at the POS terminal of the merchant 106 and at the mobile device 104. This advantageously permits the IVA 114 to verify whether mobile electronic device 104 is actually located near the terminal during a payment transaction. This may be accomplished utilizing ambient light sensors typically incorporated on a mobile device 104. The captured data from each of the sensors may then be sent to IVA 114 for identity verification. More specifically, the IVA 114 engages in a comparison between the captured ambient light data from mobile electronic device 104 and the POS terminal of the merchant 106. If the data from both do not substantially correspond to one another, the consumer's identity will not be authenticated and the transaction will be denied. If the data does substantially correspond, the consumer's identity will be authenticated. This authentication prevents those devices attempting to effectuate a fraudulent transaction without actually being in front of, or within the physical proximity to, the merchant 106.

With reference to FIGS. 2 and 11, step 1122 of the exemplary authentication process 424 includes the IVA 114 accessing and analyzing one or more of the user's social media accounts to verify the consumer's identity. This may utilize known data mining and extraction methods currently employed by those skilled in the art. Before the financial transaction is instituted, the IVA 114 requests permission from the user (possibly during the initial registration) to access the user's social media account. As such, the “social media account” may include one or more servers 202 associated with the user's social media account. Accessing the user's social media account may include obtaining the user's username(s) and password(s) of the social media accounts, which may be cached on the STS 108, including the database 120, for further use by the IVA 114. This username and password is also referred to herein as a “social-media-user identifier.” As the social-media-user identifier is given before the consumer's identity is verified, accessing the user's social media account(s) may be carried out without any interaction from the user, i.e., a user-free electronic interaction.

The STS 108, through the IVA 114, may then compile, or gather, information or data relating to the user. Some of this information or data may include the location of the user and the date/time stamp when said location was updated or uploaded to the social media account. In addition, social media data may include other updated information such as photos, when those photos were added the number of social media contacts/friends, when those contacts/friends were added, and also the activity the user has had with those contacts/friends or other users of the social media account.

In one embodiment, the IVA 114 may employ the use of the identifying and comparing the user's social media location (i.e., through status updates) and consumer's location (i.e., where the transaction occurred) to authenticate a consumer transaction. For example, a location of the consumer's transaction is received by the IVA 114 by the consumer's mobile device 104 or the merchant 106, also called a “transaction-location identifier.” The consumer's location is then compared to a location obtained from the user's social media server, also called a social-media-user-location identifier. Generally, the location of a user is uploaded to the social media server when the user update's his or her status, also called “status updates” or “checking in.” If the social-media-user-location identifier reflects a location, e.g., county or state, outside of the county where the transaction occurred, the transaction may be denied. The IVA 114 may also take into account when the social-media-user-location identifier was updated, when the closer in time social-media-user-location identifier was updated, compared to the transaction-location identifier, indicating a positive user-identity verification. In some embodiments, location identifiers that do not correspond to one another, i.e., the consumer and user are located in different counties, states, etc., the IVA 114 will not result in a failed transaction, but rather will result in additional identity authentication being required from the consumer. In other embodiments, the consumer's identity will not be authenticated and the transaction will ultimately be declined. In essence, the user may simultaneously prevent fraudulent transactions by updating their location status through their social media account, which many users find beneficial.

In further embodiments, the IVA 114 may determine a social-media-user-identity-verification score, which is similar to a credit score. This social-media-user-identity-verification score may be based on the level of activity associated with the user's social media account, the location of the transaction with respect to the last updated location of the user on his or her social media account, among other factors. These factors are also referred to herein as “social media user data.” Depending on many of the factors stated above, e.g., activity of uploaded photos, the user's social media account will be given a score. The more activity designates a higher score. To determine the positive or failed user-identity verification, the social-media user-identity-verification score is then compared to a stored threshold value. The social-media user-identity-verification score may also be based on distance between the last known location updated by the user on the social media account and the location where the consumer initiates the transaction.

The stored threshold value may be stored on the database 120 or any other memory associated with the IVA 114. For example, a user may have a social-media-user-identity-verification score of 10 points because of having, within the last week: (1) adding one friend to his or her social media account, (2) updating their status twice, (3) uploading five photos, and (4) checking-in to a location within fifteen miles of the transaction location-identifier. If the stored threshold value is 8, the transaction will be approved. In other embodiments, different values may be given to both the various social media user data and the stored threshold value.

The IVA 114 will then utilize the score to either authenticate a consumer or ultimately deny a financial transaction. The score may be stored in the database 120 and may also be influenced and indicative of other factors, such as the user/consumer's purchase history. As a result, the more user/consumer transactions, particularly in the same city or state as the location of the transaction being analyzed, the higher the resulting social-media-user-identity-verification score. In addition to giving a user and merchant an additional authentication protocol, this authentication feature may also prevent those unfortunate instances where a user is injured, deceased, or otherwise incapacitated, and is a victim of identity theft.

In another embodiment of the present invention, the IVA 114 may utilize the global positioning of the mobile device 104 to authenticate the consumer. This exemplary feature is shown in step 1124 of the authentication process 424 and involves the use of the mobile device's global positioning system and its corresponding satellites. In one example of use, the user initially designates a region or area where transactions would be permissible, called an “authorized-transaction-location identifier.” These regions or areas are then stored on the STS 108 or otherwise available for use by the IVA 114. When the STS 108 receives a payment request, the IVA 114 then captures/receives the GPS location of the mobile device 104, i.e., the “transaction-location identifier,” and compares it to the authorized-transaction-location identifier. Said another way, the IVA 114 determines whether the financial transaction takes place within the predefined areas or locations set by a user. In other embodiments, the transaction-location identifier may be sent by merchant 106 to the STS 108. This advantageously prevents fraud from occurring outside of those areas where the user lives or typically conducts financial transactions. In further embodiments, the user may also designate authorized regions or areas depending on the date/time of the financial transaction. This is extremely beneficial for parents and employers attempting to monitor and track financial transactions, while at the same time preventing abuse and minimizing fraud.

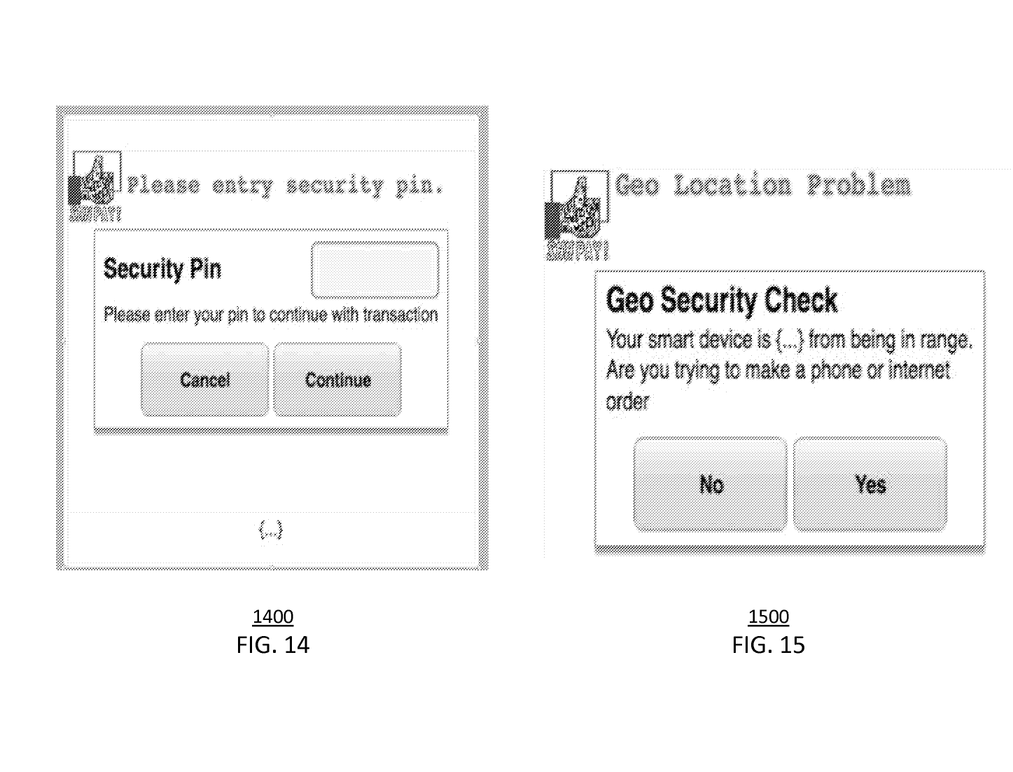

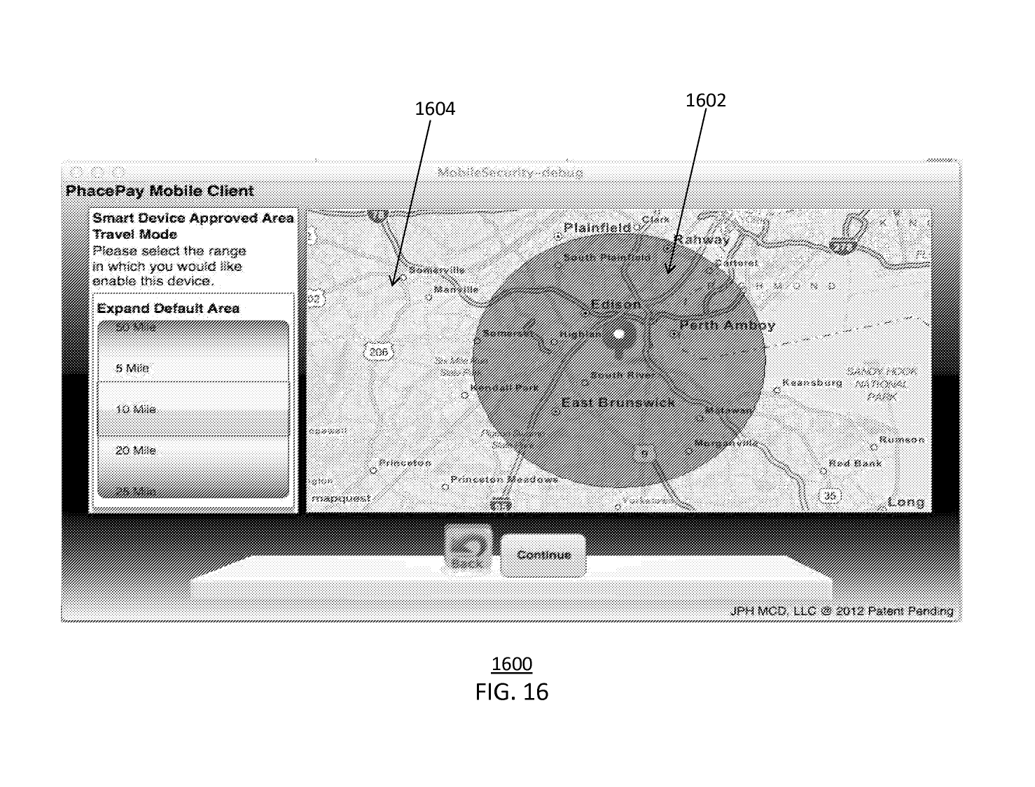

With reference now to FIG. 15, a screenshot 1500 of a consumer prompt is shown. If the geographic location of the consumer's mobile device 104, i.e., the transaction-location identifier, does not correspond to the stored permissible locations set by the user, i.e., the authorized-transaction-location identifier, the consumer will be warned that they are outside of those permissible locations. In certain instances, the miles or range from being a permissible location may be shown. The consumer may also be prompted whether the transaction is made by phone or Internet, such that the geographic location would prevent the consumer from making the transaction. As such, the system may utilize other authentication protocols, e.g., biometric data, to authenticate the consumer. FIG. 16 also depicts a screenshot 1600 representing the consumer's purchase lying outside of the purchasing range 1602 or a permissive perimeter. The consumer may then be prompted, through the IVA 114 for example, as to whether the consumer desires to change the purchasing range 1602. The permissive range 1602 may be designated by radial miles from a particular point, by county, by city, by state, or other factors.

In another example of the authentication feature reflected in step 1124 of FIG. 11, the IVA 114 receives location data corresponding to the purchasing history of the consumer, or “past-transaction-location identifiers.” This of course would be based on those instances where the consumer has been authenticated for the financial transaction. As such, the STS 108 may store the past-transaction-location identifiers, on the database 120 for example. The IVA 114, or other processing device, may then determine and associate the authorized-transaction-location identifier, which may include a permissive transaction radius, county, or other identifier, based on those past-transaction-location identifiers. In further embodiments, the permissive transaction region is indicative of the amount of time the consumer spends in the particular location or the number of times the consumer has visited that particular location.

For example, if the consumer conducted ten previous transactions in a particular city, within a particular county, the IVA 114 may be programmed to indicate the city as the authorized-transaction-location identifier. As such, if a transaction-location identifier originates from the city that was authorized, the positive user-identity verification may issue without any other identity verification protocols. If the transaction-location identifier originates outside of that city, but within the county, another identity verification protocol may be issued by the IVA 114, which is perhaps less intrusive, e.g., photo verification. If the transaction-location identifier originates outside of that city and the county, another identity verification protocol may be issued, which is perhaps more intrusive, e.g., receiving biometric data from the consumer. If the consumer's identity is verified, the new city/county/state may then be added as an authorized authorized-transaction-location identifier. This intelligent transaction tracking process may utilize a variety of factors, such as the date and time of said transactions and the repetitiveness of the transaction-location identifiers. The IVA 114 may also be programmed to determine the authorized-transaction-location in terms of the region where previous transaction-location identifiers indicate the transaction occurred. Then, using the region, provide and indicate a radial distance away from that region as an authorized-transaction-location identifier.

After the IVA 114 has confirmed that the transaction is taking place within a permissible transaction zone 1602, the consumer's identity may be authenticated and the payment process will be carried out through traditional payment processes. In certain embodiments, the system may not authenticate a consumer and request additional authentication, e.g., retinal scan. As with many of the aforementioned authentication protocols, the application running the IVA 114 may prompt the consumer to update the stored comparison data previously given by the user. If updated information if provided, the IVA 114 is operable to re-authenticate the consumer's identity. In yet further embodiments, the application may also permit the consumer to process a one-time financial transaction outside of the permissible transaction region(s) 1602. The permissive transaction region(s) 1602 may be also displayed on the mobile electronic device 104, with the permissive or authorized location 1602 and the unauthorized zone 1604 being displayed in contrasting colors or designs. The mobile electronic device may also include a plurality of marks on a map that represent purchases within a particular time period. This beneficially helps the user determine whether a new zone should be added or whether an existing authorized zone 1602 should be expanded.

In yet further embodiments, the permissive transaction region 1602 may represent the user's zip code. As multiple persons or groups may be designated as “authorized” users, the STS 108 may determine the scope of the permissive transaction regions 1602 based on the spending habits of the group. The user may also designate certain zip codes to certain individuals on the group and have the STS 108 designate the permissive transaction region 1602 accordingly. The permissive transaction region 1602 may also be determined by the distance from the last submitted billing address of the user. While the permissive transaction region 1602 is shown as a circle, it may be represented as a square, rectangle, or any other shape.

In certain embodiments, upon proper authentication, the user may also select how long new permissive transaction region 1602 will remain “authorized” or “permissive.” For example, if a user visits France on vacation for a week, the user may add certain cities or areas in France, and based upon the user's itinerary, he or she can add the permissive transaction region 1602 for an hour, day, week, every other Monday, once per year or other specified possible time period(s). In other embodiments, the user may place the IVA 114 in “travel mode.” Travel mode would prevent the IVA 114 from authorizing financial transactions occurring both inside and outside of the permissive transaction region(s) 1602. Thus, in order to complete a financial transaction, the user must de-select travel mode.

The Financial Transaction—Payment to Merchant

FIG. 17 depicts an exemplary settlement process 436 represented in FIG. 4b. Settlement processes for transferring funds from a financial institution to a merchant are generally known in the art and are generally conducted over a settlement network 118 (shown in FIG. 1). The process 436 starts at step 1700 and then immediately proceeds to step 1702 of the consumer submitting the payment identifier and the payment amount to the secured transaction server (STS) 108. As stated above, this is generally transmitted through the consumer's mobile electronic device 104. In the preferred embodiment, the inventive consumer authentication process should be carried out before the payment request is sent to the user's financial institution 110, i.e., the settlement process. In other embodiments, the settlement process 436 may occur after the consumer's identity has been authenticated.

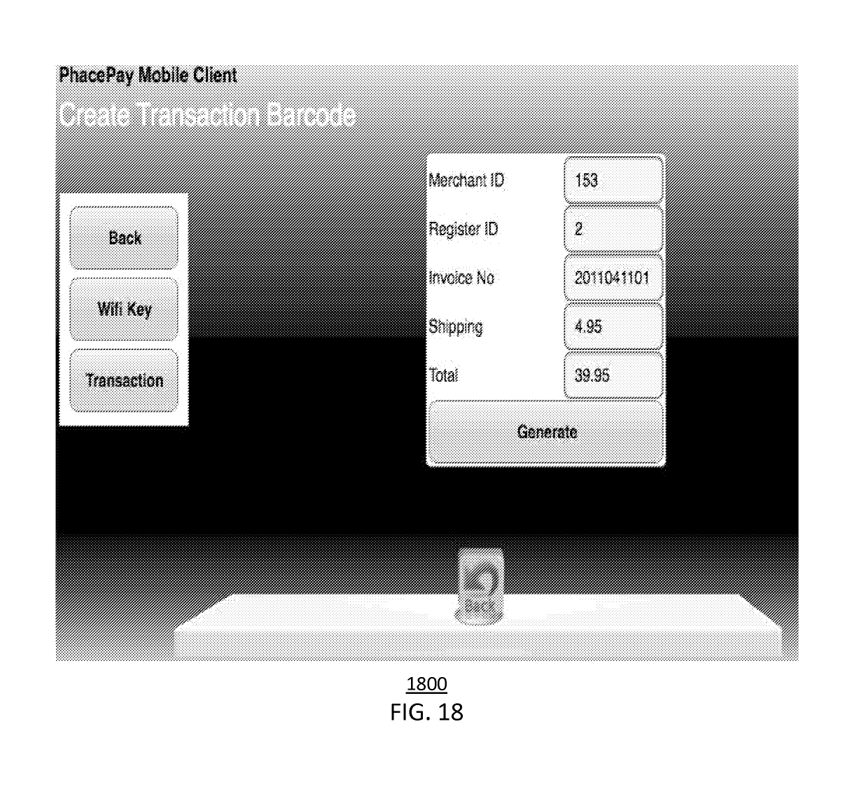

Although the payment identifier and amount may be communicated to the STS 108 with the consumer's electronic mobile device 104, one or more pieces of information pertaining to the financial transaction may be communicated to the STS 108 from the merchant 106. FIG. 18 depicts a screenshot 1800 from a merchant interface. As shown, the merchant interface provides the merchant 106 the ability to input transaction information such as a merchant identification number, an invoice number, notes, and the amount requested from payment. As previously discussed, the transaction information may be communicated directly to the STS 108 from the merchant 106 or through the mobile device 104, as an intermediary, to transfer the information to the STS 108.

The next step 1704 includes the STS 108 submitting the payment request to the consumer's financial institution 110 for reimbursement. This is accomplished using a settlement network 118 (shown in FIG. 1), such as VISA/MasterCard. As the user's financial institution 110 may have their own authentication protocols, the STS 108 is equipped to handle requests from the financial institution 110 and/or processors, and relay those requests to the consumer for input or notification. In other embodiments of the present invention, after the STS 108 has authenticated the consumer, the merchant 106 may submit the payment request to the consumer's financial institution. This would require, however, the consumer providing the merchant 106 with the payment identifier.

The settlement network 118 (shown in FIG. 1) is a system that processes and pays electronic debits and credits between two or more entities. Advantageously, the present invention conducts the debits and credits between the merchant 106 and the user′ financial institution 110 without providing the user's financial institution to the merchant directly. The present invention may leverage any one of a number of settlement networks—such as an Automated Clearing House (ACH), Fed Wire, account to account transfers, and others. Fed Wire is a real-time gross settlement funds transfer system operated by the Federal Reserve Banks that enables financial institutions to electronically transfer funds between its more than 8,900 participants. In conjunction with the privately held Clearing House Interbank Payments System (CHIPS), Fed Wire is the primary United States network for large-value or time-critical domestic and international payments, and is designed to be highly resilient and redundant. The average daily value of transfers over the Fed Wire Funds Service is approximately 2.3 trillion dollars and the daily average number of payments is about 532,000. Fed Wire is advantageous as it provides faster settlement than ACH (overnight vs. 3-day) and is a guaranteed payment.

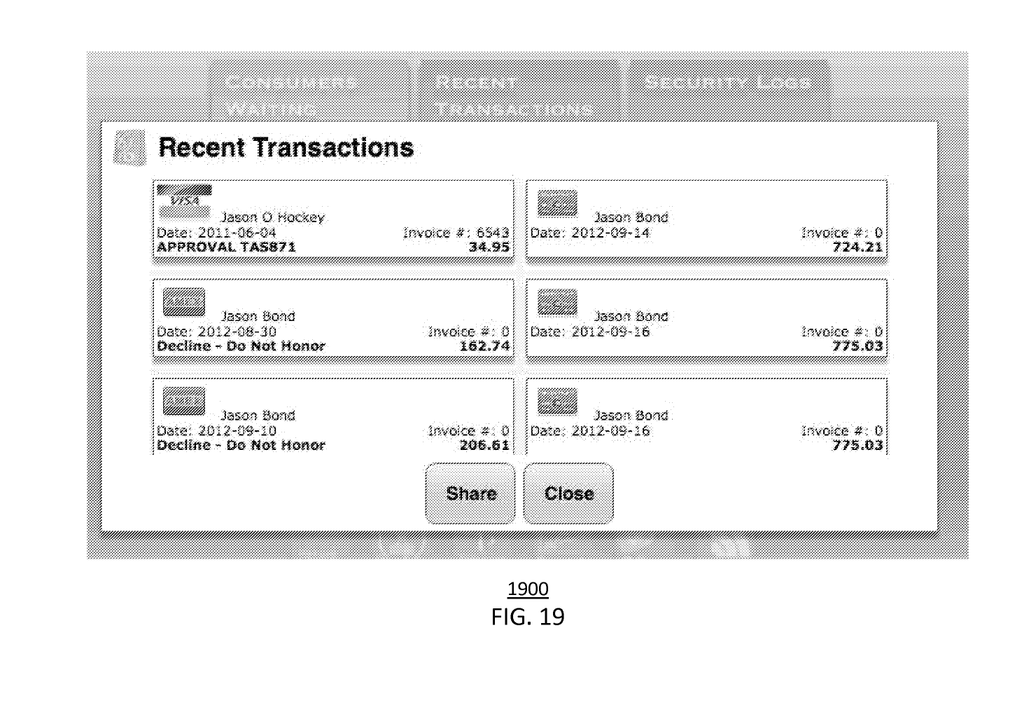

The next step 1706 includes the STS 108 receiving an approval or denial from the user's financial institution 110. This financial transaction data may be stored on the database 120 of the STS 108 or any other storing medium. Next, the process 436 continues to step 1708 of the STS 108 communicating the denial or approval to the merchant 106. In many instances, this may include an authorization code provided by the user's financial institution 110. In other embodiments, the denial/approval may be sent to the consumer/user directly wherein the consumer/user may re-designate another financial identifier. FIG. 19 depicts a screenshot 1900 from an exemplary merchant interface representing financial transactions taken place between the merchant 106 and consumers. The process 436 continues to step 1710, which, for those consumers/merchants utilizing credit cards for the financial transaction, includes communicating or “bathes” the approvals to the financial institution 110 for payment. The process continues to step 1712, with the amount of money requested (should there be an approval) being deposited or relayed (by one or more entities on the settlement network 124) to the merchant 106. The process 436 concludes at step 1714.

### Alternative Embodiments

In another embodiment of the present invention, the STS 108 causes the mobile electronic device 104 to prompt the consumer to input which merchant employee helped with the financial transaction. In one example, an alphanumerical list of employees is displayed on the mobile device 104, wherein the consumer selects the employee from that list. In yet another example, a photo of one or more employees is displayed to the consumer for the consumer to select. As such, the present invention may be utilized to track and award commission for those employees participating in a pleasant merchant/consumer financial transaction.

In further embodiments, the mobile device 104 may display a request for the consumer to input a rating for the employee that provided the assistance. The rating may be, as an example, a number rating from 1 to 10, a star rating, or other similar types of ratings. The consumer input the rating into mobile electronic device 104, such that it can be communicated to the STS 108 or merchant 106. The rating may also be uploaded and stored with social media account associated the user.

The STS 108 may also be operable to share and display merchant and employee ratings to other users/consumers connected to the network 100. These ratings are useful for other user/consumers to determine whether they want to shop at a particular merchant and/or do business with a particular employee.

In addition, the inventive process may also utilize the user/consumer's purchase information for directional advertising and/or for providing discounts to the consumers. Merchant's 106 may also utilize the user interface to generally advertise specials and discounts being offered generally to consumers.

In other embodiments, a merchant 106 may utilize interactive advertisements which provide a transaction discount to the consumer resulting from the consumer's selection of the advertisement. In yet another embodiment, the interactive advertisement allows the consumer to interact with the merchant 106 on a social networking site. The client may interact by, inter alia, following the company, liking the company, recommending the company to other social networkers, checking-in at the merchant's site via a “status update” or other known methods for checking-in, sharing information about a company, or making a post about the company.

The discount that results from interacting with a merchant advertisement is automatically added to a transaction at the point of payment. The consumer may then pay in accordance with authentication protocols provided by the present invention including any optional security fraud detection features, as further described herein.

In alternative embodiments of the authentication features of the present invention, a database may be utilized to store medical history and information of patient (formally a “user”). The user, in accordance with above-described features and characteristics, set authentication and permission parameters to control which individuals (formally a “consumer”) may access, view, and are otherwise authorized to view the medical history and information. After authentication, the protected information may be viewable on a remote device, including, inter alia, doctors, nurses, firefighters and insurance companies, as well as their staff. Individuals with access rights may view and receive those medical documents. The IVA 114 may monitor the remote devices, in a manner consistent with the security methods described in this application, to prevent transferring information to fraudulent individuals. The IVA 114 may be operable to alert the patient when authorized individuals access and/or view medical history and information. The security features discussed herein may be adapted to prevent insurance fraud and similar types of identity theft. As such, requests from entities and/or persons, e.g., a medical staff member, must be verified by patient before the information may be provided. If the identity of the patient is authenticated, the transaction will be refused by the IVA 114, a server (formally the STS 108) communicatively coupled to the IVA 114, or both. As such, patient records are kept confidential and less susceptible to fraud.

### CONCLUSION

A method for conducting a secured transaction with a merchant over a network has been disclosed that confirms and/or verifies a consumer's identity before completing a financial transaction with a merchant. The inventive process stores a user's authentication information on a server independent of the merchant, thereby permitting the user to advantageously conduct a financial transaction with a merchant. This financial transaction is at least partially carried out over a user's portable electronic device that is communicatively coupled to a network, such as a computer network. This allows the present invention to be utilized in almost any merchant location, without the use of extensive ancillary equipment at the point-of-sale (POS) terminal. The portable device is operable to scan/receive information associated with one or more merchant products. This information typically includes the products price.

The consumer then sends that information to the secured transaction server (STS) where the STS participates in an authentication process based on one or more verification parameters. One important verification parameter/protocol includes comparing a stored unique mobile device identifier, e.g., MAC address, given by the user to the unique mobile device identifier generated by the portable device of the consumer. Other parameters/protocols may be used such as (1) user identification data (e.g., retinal scans comparisons, photo identification, signature comparisons, voice comparisons, etc.), (2) phone identifying information (e.g., components located mobile device such as a gyroscope and accelerometer, ambient light sensors, global positioning sensors (GPS), etc.), and (3) compiling and analyzing social media information of the user. All of these verification and identification means may be used independent of, or in combination with, one another.

After the merchant receives verification from the secured transaction server, the secured transaction server, or the merchant, sends payment for authorization at the user/consumer's financial institution for authorization. Once authorization has been approved by the financial institution, the merchant receive payment though traditional settlement means. Although the present invention provides fraud prevention within the application of merchant/consumer transaction, it shall not be so limited, and the above- and below-described features and identification features may be applied to identification for medical records/payment, governmental services, corporate/employee transactions, internet and web-based transactions, among other uses.

What is claimed is:

1. A method for verifying a consumer's identity in connection with a transaction involving a consumer and a merchant, the method comprising:
receiving a user-identifier from a user;
receiving a unique device identifier from an electronic device associated with the user;
receiving a plurality of mobile-device-component identifiers from the electronic device of the user, wherein the plurality of mobile-device-component identifiers are associated with features of the electronic device that include an accelerometer, a gyroscope, a GPS system, a proximity meter, a light sensor, a camera, and a flash;
associating the user-identifier and the unique device identifier of the user to a user account at least one of:
residing on a secured transaction server; and
accessible to a secured transaction server,
wherein the secured transaction server is not operated by the merchant and includes an identity verification agent;
receiving, at the secured transaction server, a consumer identity verification request, from
an electronic device operated by the consumer,
wherein the electronic device of the consumer is communicatively coupled, over a network, to the secured transaction server;
receiving a unique device identifier associated with the electronic device of the consumer at the secured transaction server;
comparing, through the identity verification agent, the user's unique device identifier and the consumer's unique device identifier to determine at least one of:
a positive user-identity verification; and
a failed user-identity verification; and
receiving a plurality of mobile-device-component identifiers from a mobile device of the consumer, wherein the plurality of mobile-device-component identifiers are associated with features of the mobile device that include an accelerometer, a gyroscope, a GPS system, a proximity meter, a light sensor, a camera, and a flash;
comparing, through the identity verification agent, the user's plurality of mobile-device-component identifiers and the consumer's plurality of mobile-device-component identifiers to determine at least one of a positive secondary user-identity verification and a failed secondary user-identity verification;
communicating to the merchant the at least one of the positive user-identity verification and the failed user-identity verification for a user-identity-verification indicator.

2. The method according to claim 1, wherein:
the unique device identifier is a unique mobile device identifier from a mobile electronic device associated with at least one of the user and the consumer.

3. The method according to claim 2, further comprising:
initiating a secondary user authentication upon determining the at least one of the positive user-identity verification and the failed user-identity verification.

4. The method according to claim 3, further comprising:
receiving a user's biometric data;
receiving a consumer's biometric data; and
comparing, through the identity verification agent, the user's biometric data and the consumer's biometric data to determine at least one of a positive secondary user-identity verification and a failed secondary user-identity verification.

5. The method according to claim 3, further comprising:
receiving a passcode from the user;
receiving a passcode from the consumer; and
comparing, through the identity verification agent, the user's passcode and the consumer's passcode to determine at least one of a positive secondary user-identity verification and a failed secondary user-identity verification.

6. (canceled)

7. The method according to claim 3, wherein the secondary user authentication comprises:
receiving and storing a digital image of the user;
communicating the user's digital image to the merchant;
displaying the user's digital image to a display associated with the merchant;
visually comparing the user's digital image to a consumer's image to determine at least one of a positive secondary user-identity verification and a failed secondary user-identity verification; and
receiving, from the merchant, the at least one of the positive secondary user-identity verification and the failed secondary user-identity verification for the user-identity-verification indicator.

8. The method according to claim 3, further comprising:
receiving a social-media-user identifier from the user;
engaging in a user-free electronic interaction with a social media account of the user using the social-media-user identifier;
receiving a social-media-user-location identifier;
receiving a transaction-location identifier; and
comparing, through the identity verification agent, the social-media-user-location identifier and the transaction-location identifier to determine at least one of a positive secondary user-identity verification and a failed secondary user-identity verification.

9. The method according to claim 3, wherein the secondary user authentication comprises:
receiving a social-media-user identifier from the user;
engaging in a user-free electronic interaction with a social media account of the user using the social-media-user identifier;
compiling social media user data to determine a social-media-user-identity-verification score; and
comparing, through the identity verification agent, the social-media-user-identity-verification score to a secured threshold value to determine at least one of a positive secondary user-identity verification and a failed secondary user-identity verification.

10. The method according to claim 3, further comprising:
receiving an authorized-transaction-location identifier from the user;
receiving a transaction-location identifier; and
comparing, through the identity verification agent, the authorized-transaction-location identifier and the transaction-location identifier to determine at least one of a positive secondary user-identity verification and a failed secondary user-identity verification.

11. The method according to claim 3, further comprising:
determining, through the identity verification agent, an authorized-transaction-location identifier based from a plurality of past-transaction-location identifiers;
receiving a transaction-location identifier; and
comparing, through the identity verification agent, the authorized-transaction-location identifier and the transaction-location identifier to determine at least one of a positive secondary user-identity verification and a failed secondary user-identity verification.

12. A method for verifying a consumer's identity in connection with transaction involving a consumer and a merchant, the method comprising:
communicating a user-identifier from a user to a secured transaction server;
communicating a unique mobile device identifier from a mobile electronic device associated with the user to the secured transaction server;
associating the user-identifier and the unique mobile device identifier of the user to a user account residing on the secured transaction server, the secured transaction not operated by the merchant and including an identity verification agent;
communicating a consumer identity verification request, from at least one of a mobile electronic device of the consumer and the merchant, to the secured transaction server, the at least one of the mobile electronic device of the consumer and the merchant being communicatively coupled, over a network to the secured transaction server;
communicating a unique mobile device identifier associated with the mobile electronic device of the consumer to the secured transaction server;
comparing, through the identity verification agent, the user's unique mobile device identifier and the consumer's unique mobile device identifier to determine at least one of a positive user-identity verification and a failed user-identity verification for a user-identity-verification indicator; and
receiving the at least one of the positive user-identity verification and the failed user-identity verification.

13. The method according to claim 12, further comprising:
initiating a secondary user authentication, through the identity verification agent, upon determining the at least one of the positive user-identity verification and the failed user-identity verification.

14. The method according to claim 13, wherein the secondary user authentication comprises:
communicating a plurality of mobile-device-component identifiers from the mobile device of the user to the secured transaction server;
communicating a plurality of mobile-device-component identifiers from the mobile device of the consumer to the secured transaction server; and
comparing, through the identity verification agent, the user's plurality of mobile-device-component identifiers and the consumer's plurality of mobile-device-component identifiers to determine the at least one of the positive user-identity verification and the failed user-identity verification.

15. The method according to claim 13, wherein the secondary user authentication comprises:
communicating a digital image of the user to the secured transaction server;
receiving the user's digital image at the merchant;
displaying the user's digital image to a display associated with the merchant;
visually comparing the user's digital image to a consumer's image to determine the at least one of the positive user-identity verification and the failed user-identity verification; and
communicating the at least one of the positive user-identity verification and the failed user-identity verification to the secured transaction server for the user-identity-verification indicator.

16. The method according to claim 13, wherein the secondary user authentication comprises:
communicating an authorized-transaction-location identifier from the user to the secured transaction server;
communicating a transaction-location identifier, from the at least one of the mobile electronic device of the consumer and the merchant, to the secured transaction server; and
comparing, through the identity verification agent, the authorized-transaction-location identifier and the transaction-location identifier to determine the at least one of the positive user-identity verification and the failed user-identity verification.

17. The method according to claim 13, wherein the secondary user authentication comprises:
determining, through the identity verification agent, an authorized-transaction-location identifier based from a plurality of past-transaction-location identifiers communicated to the secured transaction server;
communicating a transaction-location identifier to the secured transaction server; and
comparing, through the identity verification agent, the authorized-transaction-location identifier and the transaction-location identifier to determine the at least one of the positive user-identity verification and the failed user-identity verification.

18. A method for conducting a secured transaction with a merchant over a network, the method comprising:
receiving a user-identifier and a payment identifier from a user;
receiving a unique mobile device identifier from a mobile electronic device associated with the user;
associating the user-identifier and the unique mobile device identifier of the user to a user account residing on a secured transaction server, the secured transaction server not being operated by the merchant and including an identity verification agent;
communicating an amount, associated with at least one purchase selection from the merchant, to a mobile electronic device of a consumer;
receiving the amount, the payment identifier, and a unique mobile device identifier associated with the mobile electronic device of the consumer at the secured transaction server;
comparing the user's unique mobile device identifier and the consumer's unique mobile device identifier, through the identity verification agent, to determine for a user-identity-verification indicator based on at least one of a positive user-identity verification and a failed user-identity verification;
communicating the payment identifier and amount, upon determining the positive user-identity verification, to a financial institution server associated with the payment identifier, for payment of the amount; and
relaying the amount to the merchant for payment of the at least one purchase selection.

19. The method according to claim 18, further comprising:
communicating the amount, associated with the at least one purchase selection from the merchant, to the mobile electronic device of the consumer located within a physical proximity of a point-of-sale terminal of the merchant.

20. The method according to claim 18, further comprising:
initiating a secondary user authentication upon determining the at least one of the positive user-identity verification and the failed user-identity verification, the secondary user authentication including:
receiving a user's biometric data at the secured transaction server;
receiving a consumer's biometric data at the secured transaction server; and
comparing, through the identity verification agent, the user's biometric data and the consumer's biometric data to determine the at least one of the positive user-identity verification and the failed user-identity verification.
